(19) United States
(12) Patent Application Publication
(10) Pub. No.: US 2017/0300340 A1
(43) Pub. Date: Oct. 19, 2017

(54) SECURE COMPUTER ACCESS USING REMOVABLE BOOTABLE DRIVES

(71) Applicant: Sunland International, LLC, Campbell, CA (US)

(72) Inventor: Murray John Ellis, II, Campbell, CA (US)

(21) Appl. No.: 15/486,253

(22) Filed: Apr. 12, 2017

Related U.S. Application Data
(60) Provisional application No. 62/323,554, filed on Apr. 15, 2016.
(60) Provisional application No. 62/419,433, filed on Nov. 8, 2016.

(51) Int. Cl. G06F 9/44; G06F 13/42

(52) U.S. Cl. CPC G06F 9/4406; G06F 13/4282; G06F 2213/0032

(57) ABSTRACT

Systems, methods, and non-transitory computer-readable media for providing access to small form factor (SFF) and laptop computers using removable bootable drives (RBD(s)) are disclosed herein. In some implementations, a physical RBD vault that contains RBD(s) is provided instructions to release an RBD for a specific secured usage that corresponds to a usage context of a user of a specific secured system. The RBD may comprise an SFF RBD that is configured to be inserted into an RBD enclosure created for an SFF laptop. The RBD may comprise a laptop RBD that is configured to be inserted into an RBD enclosure that is, in turn, built into a battery pack of the laptop computer.

### CLAIM OF PRIORITY

The present application claims priority to provisional U.S. Pat. App. Ser. No. 62/323,554, filed Apr. 15, 2016, entitled, “Removable SSD Drive and Housing,” and to provisional U.S. Pat. App. Ser. No. 62/419,433, filed Nov. 8, 2016, entitled, “Solid State Disk (SSD) Drive Kit.” The contents of provisional U.S. Pat. App. Ser. No. 62/323,554 and provisional U.S. Pat. App. Ser. No. 62/419,433 are hereby incorporated by reference.

### BACKGROUND

Computer security is important to many entities, including government agencies, corporations (including those that maintain private data), non-profit organizations, and individuals. However, computer security has become more difficult to maintain, especially as smaller computer systems, such as small form factor (SFF) computers and laptop computers, have become more prevalent in different contexts. In addition to being vulnerable to external threats from viruses or computer systems outside an entity's firewall, SFF and laptop computers may also be particularly vulnerable to internal threats from authorized users. As examples, SFF and laptop computers may be at risk for theft and/or to have malicious code placed on them by authorized users. While it may be desirable to protect against computer security threats, existing systems have not always been able to do so.

### SUMMARY

Systems, methods, and non-transitory computer-readable media for providing secure access to small form factor (SFF) and laptop computers using removable bootable drives (RBD(s)) are disclosed herein. In some implementations, a physical RBD vault that contains RBD(s) is provided instructions to release an RBD for a specific secured usage that corresponds to a usage context of a user of a specific secured system. The RBD may comprise an SFF RBD that is configured to be inserted into an RBD enclosure created for an SFF laptop. The RBD may comprise a laptop RBD that is configured to be inserted into an RBD enclosure that is, in turn, built into a battery pack of the laptop computer.

A method may include: gathering an identifier of a specific secured system, the specific secured system having a removable bootable drive (RBD) enclosure, the RBD enclosure supporting a power interface to receive power from the specific secured system and a data interface to receive data from the specific secured system; gathering an identifier of a secured usage, the secured usage corresponding to a usage context of the specific secured system by a user of the specific secured system; gathering an identifier of an RBD, the RBD configured to support the usage context by the user, the RBD configured to provide boot software and an operating system for the specific secured system, and the RBD being stored in a secure physical RBD vault; providing instructions to the secure physical RBD vault to release the RBD from the secure physical RBD vault, thereby facilitating the usage context.

In some implementations, the usage context may be a government security usage context, a corporate Intranet usage context, and a confidential data usage context.

In some implementations, the method further may comprise: providing a first instruction to insert the RBD in the RBD enclosure; providing a second instruction to connect a robust RBD interface of the RBD to the power port or the data port of the specific secured system. The RBD interface is robust because it is formed of a sturdy material capable of withstanding daily, or even more frequent, insertions.

The specific secured system may comprise a small form factor (SFF) device or a laptop device. The secure physical RBD vault may receive the instructions to release the RBD over a computer network.

The method may further comprise: receiving a user identifier of the user; verifying the user identifier; providing the instruction in response to verifying the user identifier.

The method may further comprise displaying, on an RBD allocation system, the instructions to release the RBD. In some implementations, the RBD allocation system may be incorporated into a touchscreen display of the secure physical RBD vault. In some implementations, the RBD allocation system may be incorporated into a mobile phone associated with the user.

The method may comprise receiving a user identifier of the user at an RBD allocation system. The method may comprise providing instructions to track the RBD after release of the RBD from the secure physical RBD vault.

A removable bootable drive (RBD) allocation control system may comprise: a secured system management engine configured to gather an identifier of a specific secured system, the specific secured system having a removable bootable drive (RBD) enclosure, the RBD enclosure supporting a power interface to receive power from the specific secured system and a data interface to receive data form the specific secured system; a secured usage management engine configured to gather an identifier of a secured usage, the secured usage corresponding to a usage context of the specific secured system by a user of the specific secured system; an RBD management engine configured to gather an identifier of an RBD, the RBD configured to support the usage context by the user, the RBD configured to provide boot software and an operating system for the specific secured system, and the RBD being stored in a secure physical RBD vault; a secured physical RBD vault management engine configured to provide instructions to the secure physical RBD vault to release the RBD from the secure physical RBD vault, thereby facilitating the usage context.

In some implementations, the usage context may be a government security usage context, a corporate Intranet usage context, and a confidential data usage context. The system may comprise an RBD configuration engine configured to: provide a first instruction to insert the RBD in the RBD enclosure; provide a second instruction to connect a robust RBD interface of the RBD to the power port or the data port of the specific secured system.

In some implementations, the specific secured system may comprise a small form factor (SFF) device or a laptop device. The secure physical RBD vault may receive the instructions to release the RBD over a computer network.

The system may comprise a user identifier management engine configured to: receive a user identifier of the user; verify the user identifier; provide the instruction in response to verifying the user identifier.

In some implementations, the system may comprise an RBD allocation system including a display management engine configured to display the instructions to release the RBD. The RBD allocation system may be incorporated into a touchscreen display of the secure physical RBD vault. The RBD allocation system may be incorporated into a mobile phone associated with the user.

In some implementations, the system may comprise a user identifier management engine configured to receive a user identifier of the user at an RBD allocation system. The system may comprise an RBD tracking engine configured to provide instructions to track the RBD after release of the RBD from the secure physical RBD vault.

A system may comprise: means for gathering an identifier of a specific secured system, the specific secured system having a removable bootable drive (RBD) enclosure, the RBD enclosure supporting a power interface to receive power from the specific secured system and a data interface to receive data form the specific secured system; means for gathering an identifier of a secured usage, the secured usage corresponding to a usage context of the specific secured system by a user of the specific secured system; means for gathering an identifier of an RBD, the RBD configured to support the usage context by the user, the RBD configured to provide boot software and an operating system for the specific secured system, and the RBD being stored in a secure physical RBD vault; means for providing instructions to the secure physical RBD vault to release the RBD from the secure physical RBD vault, thereby facilitating the usage context.

AN RBD may comprise: an RBD housing; an accessibility tab coupled to the RBD housing; a quick-insertion guide formed in the RBD housing; a robust RBD interface coupled to the RBD housing; a storage device coupled to the robust RBD interface, wherein the storage device has boot software and operating system software stored thereon; wherein, in operation, the accessibility tab provides a useful grip for an entity performing a task of mating the quick-insertion guide with a corresponding portion of a small form factor (SFF) device to facilitate operationally coupling the robust RBD interface with a corresponding power and data interface of the SFF device, wherein, when the SFF device and RBD device are operationally combined to form an SFF computing device, the SFF computing device may be bootable using the boot software and the SFF computing device operates in accordance with the operating system software.

In some implementations, the storage device may include a solid state drive (SSD). The storage device may include an internal drive enclosed within the RBD housing. The storage device may include an M Dot Two (M.2) drive or a Serial AT Attachment (SATA) drive.

An RBD interface formed of a sturdy material can be referred to as a robust RBD interface. For example, a robust RBD interface may be formed of polymethyl methacrylate (PMMA), polycarbonate, or modified PMMA or polycarbonate.

A first end of the RBD housing may be narrower than a second end of the RBD housing to form a chamfered housing. The accessibility tab may include an extension having ridges formed thereon.

The RBD may comprise a Radio Frequency Identifier (RFID) chip or a radio opaque identifier. In some implementations, the quick-insertion guide may include a quick-insertion groove or a protrusion.

A small form factor (SFF) device may comprise: a removable bootable drive (RBD) enclosure configured to receive an RBD device, wherein the RBD enclosure may include a friction-reducing air gap; a quick-insertion guide formed within the RBD enclosure; a power and data interface configured for operational coupling with a robust RBD interface; a friction-reducing air gap located inside the RBD enclosure; wherein, in operation, the quick-insertion guide may be mated with a corresponding portion of the RBD device, as part of an operation during which the RBD device may be inserted along the friction-reducing air gap, to facilitate operationally coupling the power and data interface with the robust RBD interface; wherein, when the SFF device and RBD device are operationally combined to form an SFF computing device, the SFF computing device may be bootable using boot software stored in the RBD device and the SFF computing device operates in accordance with operating system software stored in the RBD device.

In some implementations, the quick-insertion guide may include a quick-insertion groove or a protrusion. In some implementations, when the SFF device may be not operationally combined with the RBD device or another RBD device, the SFF device may be inoperable as a computing device.

A removable bootable drive (RBD) device may comprise: an RBD housing; a plurality of accessibility indentations formed on the RBD housing; a quick-insertion guide formed in an RBD enclosure coupled to a portion of a laptop device; a robust RBD interface coupled to the RBD housing; a storage device coupled to the robust RBD interface, wherein the storage device has boot software and operating system software stored thereon; wherein, in operation, the plurality of accessibility indentations provide a useful grip for an entity performing a task of mating the quick insertion guide with a corresponding portion of the RBD housing to facilitate operationally coupling the robust RBD interface with a corresponding power and data interface of the laptop device; wherein, when the laptop device and RBD device are operationally combined to form a laptop computing device, the laptop computing device may be bootable using the boot software and the laptop computing device operates in accordance with the operating system software.

In some implementations, the storage device may include a solid state drive (SSD). The robust RBD interface may be formed of a rigid material. The robust RBD interface may be formed of polymethyl methacrylate (PMMA), polycarbonate, or modified PMMA or polycarbonate.

The RBD enclosure may have a locking mechanism, the RBD has an ejection mechanism, and the ejection mechanism may be configured to facilitate unlocking of the locking mechanism. The robust RBD interface may support a Serial AT Attachment (SATA) interface to the laptop computer. The RBD enclosure may have a loading device coupled to the quick insertion guide, the quick insertion guide may be configured to load the loading device when a wall of the RBD device adjacent to the robust RBD interface exerts a force on the quick insertion guide. The loading device may be configured to support a bias point corresponding to the RBD housing being locked into the RBD enclosure. The loading device may comprise a spring.

The RBD device may have tracking technology to facilitate tracking of the RBD. The RBD device may comprise a Radio Frequency Identifier (RFID) chip or a radio opaque identifier.

### BRIEF DESCRIPTION OF THE DRAWINGS

FIG. 1 is a diagram showing an example of a secure environment.

FIG. 2 is a diagram showing an example of an RBD allocation control system, a computer-readable medium, and an RBD allocation system.

FIG. 3 is a diagram showing a flowchart of an example of a method of using a secure environment containing a secure working area and a secure removable disk (RD) storage area.

FIG. 4 is a diagram showing an example of a small form factor (SFF) device having an RBD enclosure, and capable of being coupled to an RBD.

FIGS. 5A-5M are diagrams showing an example of a small form factor (SFF) device having an RBD enclosure, and an RBD.

FIG. 6 is a diagram 600 showing examples of components of a removable disk interface used to couple a removable disk to an SFF device.

FIG. 7 is a diagram showing an example of how a removable disk interface may connect to an SFF device.

FIGS. 8A-8D are diagrams showing examples of how a removable disk interface may connect to an SFF device.

FIGS. 9A-9H are diagrams showing examples of how an RBD may be connected to an SFF device.

FIG. 10 is a diagram showing a flowchart of an example of a method of using an SFF device and an RBD.

FIGS. 11A and 11B are diagrams showing examples of a laptop device having an RBD enclosure, and capable of being coupled to an RBD.

FIGS. 12A-12H are diagrams showing examples of a laptop device having an RBD enclosure, and capable of being coupled to an RBD.

FIGS. 13A-13I are diagrams showing examples of a laptop device having an RBD enclosure, and capable of being coupled to an RBD.

FIGS. 14A-14I are diagrams showing examples of a laptop device having an RBD enclosure, and capable of being coupled to an RBD.

FIGS. 15A-15E are diagrams showing examples of an RBD.

FIG. 16 shows an example of a flowchart of a method of connecting an RBD to a laptop device.

FIGS. 17A and 17B are diagrams showing examples of an RBD enclosure.

### DETAILED DESCRIPTION

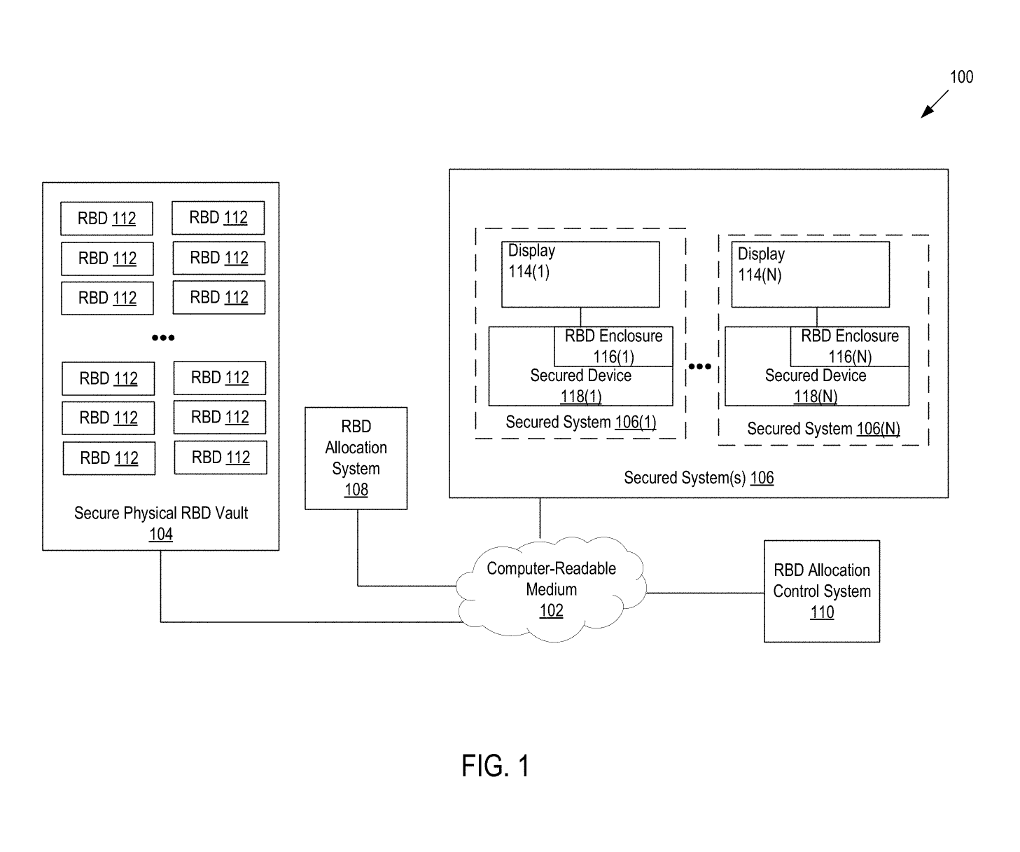

FIG. 1 is a diagram 100 showing an example of a secure environment. In the example of FIG. 1, the secure environment includes a computer-readable medium 102, a secure physical removable bootable drive (RBD) vault 104, a secured system(s) 106 (shown in FIG. 1 as including a first secured system 106(1) through an Nth secured system 106(N) and referred to as the secured system(s) 106 in this paper), an RBD allocation system 108, and an RBD allocation control system 110. In this example, the computer-readable medium 102 couples the secure physical RBD vault 104, the secured system(s) 106, the RBD allocation system 108, and the RBD allocation control system 110. In some implementations, the computer-readable medium 102 couples one or more of these components to components not explicitly shown in FIG. 1. It is noted that the couplings in FIG. 1 are by way of example only, and that one or more of the components shown in FIG. 1 may be coupled to each other or to components not explicitly shown in the figure.

The computer-readable medium 102 and other computer readable media discussed in this paper are intended to include all media that are statutory (e.g., in the United States, under 35 U.S.C. §101), and to specifically exclude all media that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may but need not be limited to hardware.

The computer-readable medium 102 and other computer-readable mediums discussed in this paper are intended to represent a variety of potentially applicable technologies. For example, the computer-readable medium 102 can be used to form a network or part of a network. Where two components are co-located on a device, the computer-readable medium 102 can include a bus or other data conduit or plane. Where a first component is co-located on one device and a second component is located on a different device, the computer-readable medium 102 can include a wireless or wired back-end network or LAN. The computer-readable medium 102 can also encompass a relevant portion of a WAN or other network, if applicable.

Assuming a computer-readable medium includes a network, the network can be an applicable communications network, such as the Internet or an infrastructure network. The term “Internet” as used in this paper refers to a network of networks that use certain protocols, such as the TCP/IP protocol, and possibly other protocols, such as the hypertext transfer protocol (hereinafter referred to as “HTTP”) for hypertext markup language (hereinafter referred to as “HTML”) documents that make up the World Wide Web (hereinafter referred to as “the web”). Networks can include enterprise private networks and virtual private networks (collectively, private networks). As the name suggests, private networks are under the control of a single entity. Private networks can include a head office and optional regional offices (collectively, offices). Many offices enable remote users to connect to the private network offices via some other network, such as the Internet.

The devices, systems, and computer-readable mediums described in this paper can be implemented as a computer system or parts of a computer system or a plurality of computer systems. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. The bus can also couple the processor to non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. Depending upon implementation-specific or other considerations, the I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, ISDN modem, cable modem, token ring interface, satellite transmission interface (e.g. “direct PC”), or other interfaces for coupling a computer system to other computer systems. Interfaces enable computer systems and other devices to be coupled together in a network.

The computer systems can be compatible with or implemented as part of or through a cloud-based computing system. As used in this paper, a cloud-based computing system is a system that provides virtualized computing resources, software and/or information to end user devices. The computing resources, software and/or information can be virtualized by maintaining centralized services and resources that the edge devices can access over a communication interface, such as a network. As used in this paper, edge devices include applicable devices at an edge of one or a combination of a LAN, a WLAN, a consumer network, and an enterprise network. For example, an edge device can be a networking device, at an edge of a LAN, providing wireless access to network services through a WLAN. In another example, an edge device can be an IoT device accessing network services through a LAN. In yet another example, an edge device can be an IoT device transmitting data through at least a portion of a wired connection, e.g. a Universal Serial Bus (hereinafter referred to as “USB”) connection. “Cloud” may be a marketing term and for the purposes of this paper can include any of the networks described herein. The cloud-based computing system can involve a subscription for services or use a utility pricing model. Users can access the protocols of the cloud-based computing system through a web browser or other container application located on their end user device.

A computer system can be implemented as an engine, as part of an engine or through multiple engines. As used in this paper, an engine includes one or more processors or a portion thereof. A portion of one or more processors can include some portion of hardware less than all of the hardware comprising any given one or more processors, such as a subset of registers, the portion of the processor dedicated to one or more threads of a multi-threaded processor, a time slice during which the processor is wholly or partially dedicated to carrying out part of the engine's functionality, or the like. As such, a first engine and a second engine can have one or more dedicated processors or a first engine and a second engine can share one or more processors with one another or other engines. Depending upon implementation-specific or other considerations, an engine can be centralized or its functionality distributed. An engine can include hardware, firmware, or software embodied in a computer-readable medium for execution by the processor. That is, the engine includes hardware. The processor transforms data into new data using implemented data structures and methods, such as is described with reference to the FIGS. in this paper.

The engines described in this paper, or the engines through which the systems and devices described in this paper can be implemented, can be cloud-based engines. As used in this paper, a cloud-based engine is an engine that can run applications and/or functionalities using a cloud-based computing system. All or portions of the applications and/or functionalities can be distributed across multiple computing devices, and need not be restricted to only one computing device. In some embodiments, the cloud-based engines can execute functionalities and/or modules that end users access through a web browser or container application without having the functionalities and/or modules installed locally on the end-users' computing devices.

As used in this paper, datastores are intended to include repositories having any applicable organization of data, including tables, comma-separated values (CSV) files, traditional databases (e.g., SQL), or other applicable known or convenient organizational formats. Datastores can be implemented, for example, as software embodied in a physical computer-readable medium on a specific-purpose machine, in firmware, in hardware, in a combination thereof, or in an applicable known or convenient device or system. Datastore-associated components, such as database interfaces, can be considered “part of” a datastore, part of some other system component, or a combination thereof, though the physical location and other characteristics of datastore-associated components is not critical for an understanding of the techniques described in this paper.

Datastores can include data structures. As used in this paper, a data structure is associated with a particular way of storing and organizing data in a computer so that it can be used efficiently within a given context. Data structures are generally based on the ability of a computer to fetch and store data at any place in its memory, specified by an address, a bit string that can be itself stored in memory and manipulated by the program. Thus, some data structures are based on computing the addresses of data items with arithmetic operations; while other data structures are based on storing addresses of data items within the structure itself. Many data structures use both principles, sometimes combined in non-trivial ways. The implementation of a data structure usually entails writing a set of procedures that create and manipulate instances of that structure. The datastores, described in this paper, can be cloud-based datastores. A cloud based datastore is a datastore that is compatible with cloud-based computing systems and engines.

Returning to the example secure environment shown in FIG. 1, the secure physical RBD vault 104 is coupled to the computer-readable medium 102. In a specific implementation, the secure physical RBD vault 104 comprises a physical area that is secure from outside physical access, physical tampering, and/or physical manipulation by unauthorized persons. In some implementations, the secure physical RBD vault 104 is locked using a physical lock that can be unlocked by electronic access codes. The secure physical RBD vault 104 may receive instructions over the computer-readable medium 102 to be locked and/or unlocked. In a specific implementation, the secure physical RBD vault 104 includes a kiosk that is coupled to the computer-readable medium 102.

In the example of FIG. 1, the secure physical RBD vault 104 includes RBD(s) 112. In a specific implementation, the RBD(s) 112 comprise an RBD housing coupled to a storage device. The RBD(s) 112 may further include accessibility areas (tabs, indentations, etc.) that allow a user to grip the RBD(s) 112 when handling the RBD(s) 112 and/or manipulating the RBD(s) 112. The RBD(s) 112 may further include quick insertion elements that allow the RBD(s) 112 to mate with enclosures (e.g., the RBD enclosure 116) formed in the secured system(s) 106 and facilitate ease of insertion. In a specific implementation, the RBD(s) 112 include a robust RBD interface that facilitates a robust coupling to data and/or power interfaces of the secured system(s) 106. The robust RBD interface is formed of a sturdy material that can withstand repeated use without breakage. For example, the robust RBD interface may be formed of polymethyl methacrylate (PMMA), polycarbonate, or modified PMMA or polycarbonate.

In various implementations, the RBD(s) 112 may be sized and/or shaped appropriately to mate with portions of the secured system(s) 106, such as to mate with the RBD enclosure 116 of the secured system(s) 106. In some implementations, the RBD(s) 112 are sized and/or shaped to include an M Dot Two (M.2) drive or a Serial AT Attachment (SATA) drive. In some implementation, a first end of the RBD housing is narrower than a second end of the RBD housing to form a chamfered housing. The RBD(s) 112 may be equipped with tracking technology (Radio Frequency Identifier (RFID) chips, radio opaque identifiers, etc.).

In the example of FIG. 1, the secured system(s) 106 are coupled to the computer-readable medium 102. In the example of FIG. 1, the secured system(s) 106 each include a display 114, an RBD enclosure 116, and a secured device 118. The secured system(s) 106 may each include one or more physical systems, that when operationally combined with the RBD(s) 112, are bootable using the boot software on the RBD(s) 112. In some, but not all implementations, the secured device 118 may include some components (graphics cards, buses, power sources, etc.) of a computing system but may lack other components (processor, memory, hard drive (magnetic or solid state),etc.) of a “computer system,” as used herein. In some implementations, the secured device 118 comprises portions of an SFF device, that when operationally combined with the RBD(s) 112, forms an SFF computing device. In various implementations, the secured device 118 comprises portions of a laptop device, that when operationally combined with the RBD(s) 112, forms a laptop computing device. In some implementations, when the secured system 106 is not operationally combined with the RBD(s) 112, the secured system 106 is inoperable as a computing device.

In the example of FIG. 1, the display 114 is coupled to the secured device 118. The display 114 may include hardware configurable to display items to a user. The display 114 may include one or more of a cathode ray display, a plasma display, a liquid crystal display (LCD), and a light emitting diode (LED) display. In various implementations, the display 114 is integrally formed and/or fused to the secured device 118 or remote from the secured device 118 and coupled via a cable, wireless connection, or the like. The display 114 could also be a handheld device, such as a smartphone, though some implementations may eschew the use of smartphones or other handheld devices (particularly BYO devices) in conjunction with the secured system 106 for security reasons. In alternative implementations, some other device replaces the display 114, such as speakers to transmit sound, buzzers, lights, or the like. Such other devices can also be implemented in addition to the display 114.

The RBD enclosure 116 is intended to represent an enclosure that can receive an RBD 112. For example, the RBD enclosure 116 can receive an RBD housing of an RBD 112. In a specific implementation, the RBD enclosure 116 contains and/or exposes power and/or data cables. For example, the RBD enclosure 116 may contain and/or expose a power cable that facilitates connection to a power source. As another example, the RBD enclosure 116 may contain and/or expose a Serial ATA (SATA) interface to transmit data to/from an RBD 112 inserted therein and other parts of the secured system(s) 106. In implementations where the secured device 118 comprises an SFF device, the RBD enclosure 116 may be configured to receive a chamfered housing with a first end that is narrower than a second end. In such implementations, the RBD enclosure 116 may have approximate dimensions of a M.2 or SATA drive.

In the example of FIG. 1, the RBD allocation system 108 is coupled to the computer-readable medium 102. The RBD allocation system 108 is intended to represent a computer system configured to receive instructions from the RBD allocation control system 110. In various implementations, the RBD allocation system 108 includes a mobile phone, tablet computing device, laptop computer, etc. associated with a user. The RBD allocation system 108 may be accessible through a touchscreen display associated with the secure physical RBD vault 104. In various implementations, the RBD allocation system 108 performs user authentication functions to determine whether a user is who the user says it is and/or authenticate a user's right to access the RBD(s) 112. In a specific implementation, the RBD allocation system 108 supports a user interface, which may or may not be a graphical user interface (GUI).

In the example of FIG. 1, the RBD allocation control system 110 is coupled to the computer-readable medium 102. The RBD allocation control system 110 is intended to represent a system that controls access to the RBD(s) 112 in the secure physical RBD vault 104. In a specific implementation, the RBD allocation control system 110 performs secured system identification functions to identify secured system(s) 104 to receive specific RBD(s) 112. In some implementations, the RBD allocation control system 110 performs secured usage identification functions to gather usage context(s) of the secured system(s) 106. A “usage context,” as used herein, may refer to circumstances of usage of secured system(s) 106. In some implementations, a usage context comprises a governmental usage context, including but not limited to specified governmental circumstances of use, specified circumstances of use where the secured system(s) 106 handle confidential information, and/or other specific circumstances of use.

In a specific implementation, he RBD allocation control system 110 performs identification and/or tracking functions that identify and/or track the RBD(s) 112 as they are released from the secure physical RBD vault 104. The RBD allocation control system 110 may also provide instructions to the RBD allocation system 108 to unlock/release/etc. the RBD(s) 112 from the secure physical RBD vault 104.

The systems of the secure environment shown in the diagram 100 operate to provide instructions to release specified RBD(s) 112 for use with secured system(s) 106. In a specific implementation, the secured physical RBD vault 104 and the secured system(s) 106 form a part of a sequestered facility. For example, the RBD(s) 112 may be secured within the secure physical RBD vault 104 and the secured system(s) 106 may be inoperative (e.g., not have a processor and/or memory) in the sequestered facility. In this example, a user may use the RBD allocation system 108 to request access to and/or release one of the RBD(s) 112 for use in one of the secured system(s) 106, rendering one of a secured system operable. The RBD allocation system 108 may provide the requests to the RBD allocation control system 110.

In a specific implementation, the RBD allocation control system 110 requests and/or identifies usage context(s) for an RBD that is to be used. The usage context(s) may depend on user needs, the needs of the secure environment, and/or specific configurations. In some implementations, the usage context(s) comprise governmental usage context(s). As an example of such a context, the secure physical RBD vault 104 and the secured system(s) 106 may be located at a sequestered facility managed by a governmental entity. The sequestered facility may require one or more levels of access and/or be have a secrecy classification level (secret, top-secret, Q-level, SCI level, etc.) The RBD(s) 112 may contain classified information. In such a context, the RBD allocation system 108 may determine whether a user has appropriate rights (clearance, appropriate username, password, other authentication, etc.) to access one or more of the RBD(s) 112. The RBD allocation system 108 may also determine whether the user has appropriate rights to access the secured system(s) 106.

In some implementations, the usage context(s) comprise a confidential data context where one or more of the RBD(s) 112 hold confidential data. A sequestered facility managed by a governmental agency be one example of such a context. As another example of such a context, the secure physical RBD vault 104 and the secured system(s) 106 may be located at a health care company that handles private data (e.g., patient data). The RBD(s) 112 may contain the private and/or confidential data, some of which may only be accessible under the appropriate usage context. In such a context, the RBD allocation system 108 may determine whether a user has appropriate rights to access one or more of the RBD(s) 112 and/or rights to access the secured system(s) 106. In some implementations, the usage context(s) comprise a corporate Intranet usage context where the secure physical RBD vault 104 and the secured system(s) 106 may be located on the premises of a corporation where private and/or secured data is kept behind a secured firewall, router, bridge, etc. The RBD(s) 112 may contain the private and/or secured data.

In a specific implementation, the RBD allocation control system 110 provides instructions to the RBD allocation system 108 to release specified RBD(s) 112. The user may gather the released RBD(s) 112 and insert the released RBD(s) 112 into an appropriate RBD enclosure 116 in one of the secured device(s) 118. The user may boot that secured device 118 using the released RBD(s) 112. In some implementations, the RBD allocation control system 110 tracks and/or otherwise manages the location of the RBD(s) 112 in the sequestered facility.

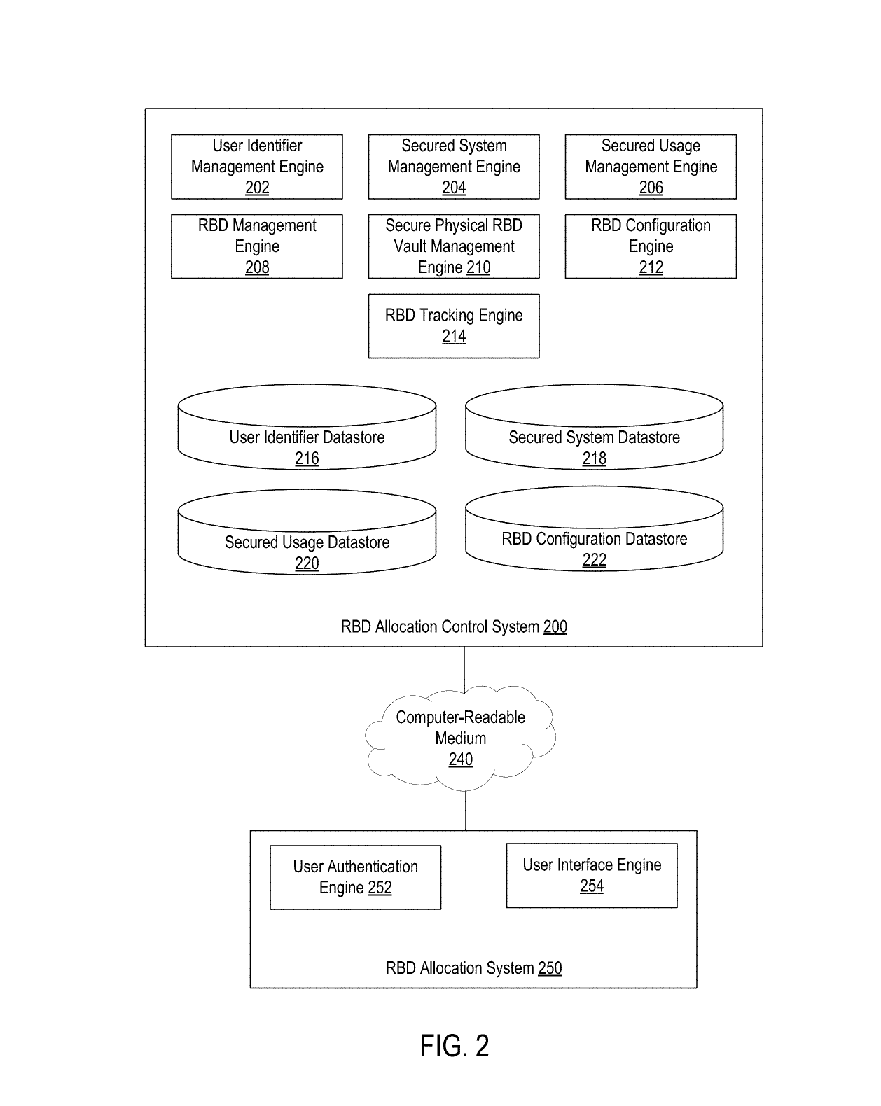

FIG. 2 is a diagram showing an example of an RBD allocation control system 200 a computer-readable medium 240, and an RBD allocation system 250. It is noted that the couplings in FIG. 2 are by way of example only, and that one or more of the components shown in FIG. 2 may be coupled to each other or to components not explicitly shown in the figure.

In the example of FIG. 2, the RBD allocation control system 200 includes a user identifier management engine 202, a secured system management engine 204, a secured usage management engine 206, an RBD management engine 208, a secure physical RBD vault management engine 210, an RBD configuration engine 212, an RBD tracking engine 214, a user identifier datastore 216, a secured system datastore 218, a secured usage datastore 220, and an RBD configuration datastore 222.

The user identifier management engine 202 is intended to represent an engine that gathers identifiers of users of secured systems. The user identifiers may include username(s), unique and/or generic alphanumeric key strings corresponding to users, passwords, etc. In a specific implementation, the user identifier management engine 202 verifies user identifiers against known user identifiers. The user identifier management engine 202 may provide one or more of the modules of the RBD allocation control system 200 regardless of whether a user identifier has been verified.

The secured system management engine 204 is intended to represent an engine that gathers identifiers of and/or manage secured systems, such as secured systems in a secure physical RBD vault. In various implementations, the secured system management engine 204 gathers from the secured system datastore 218 name(s), location(s), serial number(s), and/or other data used to identify secured system(s), either within a sequestered facility or other area.

The secured usage management engine 206 is intended to represent an engine that gathers information about secured usages, such as usage contexts, from the secured usage datastore 220. In a specific implementation, the secured usage management engine 206 provides the secured usages to other modules of the RBD allocation control system 200. As noted herein, usage contexts depend on user needs, the needs of the secure environment, and/or specific configurations. The usage contexts may comprise government security usage contexts, corporate Internet usage contexts, confidential data usage contexts, etc. The secured usage management engine 206 may provide secured usages to other modules of the RBD allocation control system 200.

The RBD management engine 208 is intended to represent an engine that gathers RBD(s) identifiers and/or RBD configuration data from the RBD configuration datastore 222. In a specific implementation, the RBD identifiers are configured to support secured usages gathered by the secured usage management engine 206. The RBD identifiers may comprise device serial numbers, device names, and/or other device information used to identify RBD(s).

The secure physical RBD vault management engine 210 is intended to represent an engine that provides instructions to a secure physical RBD vault, either through a computer-readable medium or through the RBD allocation system 250. In some implementations, the secure physical RBD vault management engine 210 manages unlocking a secure physical RBD vault and/or facilitating delivery of an RBD from a kiosk of a secure physical RBD vault kiosk.

The RBD configuration engine 212 is intended to represent an engine that gathers RBD configuration data from the RBD configuration datastore 222 and/or manage RBD configurations. RBD configuration data may include information about how RBD(s) are configured (locations, placements, uses, etc.) within a secure physical RBD vault. As an example, RBD configuration data may include specific locations of RBD(s) within a secure physical RBD vault. As another example, RBD configuration data may include specific ways RBD(s) are interrelated and/or combined with one another.

The RBD tracking engine 214 is intended to represent an engine that provides instructions to track RBD(s). In a specific implementation, the RBD tracking engine 214 identifies specific locations of RBD(s) based on tracking data associated with RBD(s). The RBD tracking engine 214 may use RFID and/or radio opaque identifiers on RBD(s) to identify the locations of the RBD(s) in a relevant area.

The user identifier datastore 216 is intended to represent a datastore configured to store user identifiers of users. User identifiers may include username(s), unique and/or generic alphanumeric key strings corresponding to users, passwords, etc. In some implementations, the user identifiers may form a basis to verify and/or authenticate a user, as discussed further in this paper.

The secured system datastore 218 is intended to represent a datastore configured to store information related to and/or identifiers of secured system(s). The secured system datastore 218 may store name(s), location(s), serial number(s), and/or other data used to identify secured system(s), either within a sequestered facility or other area.

The secured usage datastore 220 is intended to represent a datastore configured to store information related to and/or identifiers of secured usages. As noted herein, the secured usages may correspond to various usage contexts of users and/or secured system(s).

The RBD configuration datastore 222 is intended to represent a datastore configured to store RBD configuration data. RBD configuration data may include information about the hardware and/or software located on a specific RBD. RBD configuration data may also include information about how RBD(s) are configured (locations, placements, uses, etc.) within a secure physical RBD vault. RBD configuration data may include RBD tracking data.

In the example of FIG. 2, the computer-readable medium 240 couples the RBD allocation control system 200 to the RBD allocation system 250. The computer-readable medium 240 is intended to represent any applicable computer-readable medium.

In the example of FIG. 2, the RBD allocation system 250 includes a user authentication engine 252 and a user interface engine 254. The user authentication engine 252 is intended to represent an engine, alone or in conjunction with the user identifier management engine 202, that authenticates user access to RBD(s). The user interface engine 254 is intended to represent an engine that supports a user interface for a user of the RBD allocation system 250 capable of receiving instructions from a user to manage the RBD allocation control system 200 and/or the RBD allocation system 250.

In an example of operation, the RBD allocation control system 200 , the computer-readable medium 240, and/or the RBD allocation system 250 operate to provide users with RBD(s) for various usage contexts. In some implementations, the user interface engine 254 may receive an indication a user seeks to access an RBD for a particular secured usage. A user may, for instance, enter an identifier of an RBD and/or select an RBD from a graphical interface managed by the user interface engine 254. In some implementations, the user may provide the user's user identifier into a graphical interface managed by the user interface engine 254. The user authentication engine 252 may, alone or using the user identifier management engine 202, verify whether or not the user identifier is to access secured systems, RBD(s), and/or resources managed thereon. The secured system management engine 204 may operate to gather from the secured system datastore 218 an identifier of a secured system. In some implementations, the specific secured system may have an RBD enclosure that supports a power interface to receive data from the specific secured system and/or a data interface that is configured to receive data from the specific secured system.

The secured usage management engine 206 may operate to gather from the secured usage datastore 220 identifiers of one or more secured usages. The secured usage(s) may correspond to usage context(s) of the specific system (e.g., the system identified by the secured system management engine 204). The secured usage(s) may correspond to usage context(s) relevant to the user of the RBD allocation system 250. The RBD management engine 208 may operate to gather an identifier of an RBD that is configured to support the usage context by the user. The RBD, in various implementations, may be configured to provide boot software and an operating system for the specific secured system. The RBD may be stored in the secure physical RBD vault managed by the RBD allocation system 250. The secured physical RBD vault management engine 210 may operate to provide instructions to the secure physical RBD vault to release the RBD from the secure physical RBD vault to facilitate the usage context. The RBD tracking engine 214 may operate to track the RBD as it goes to the specific secured system.

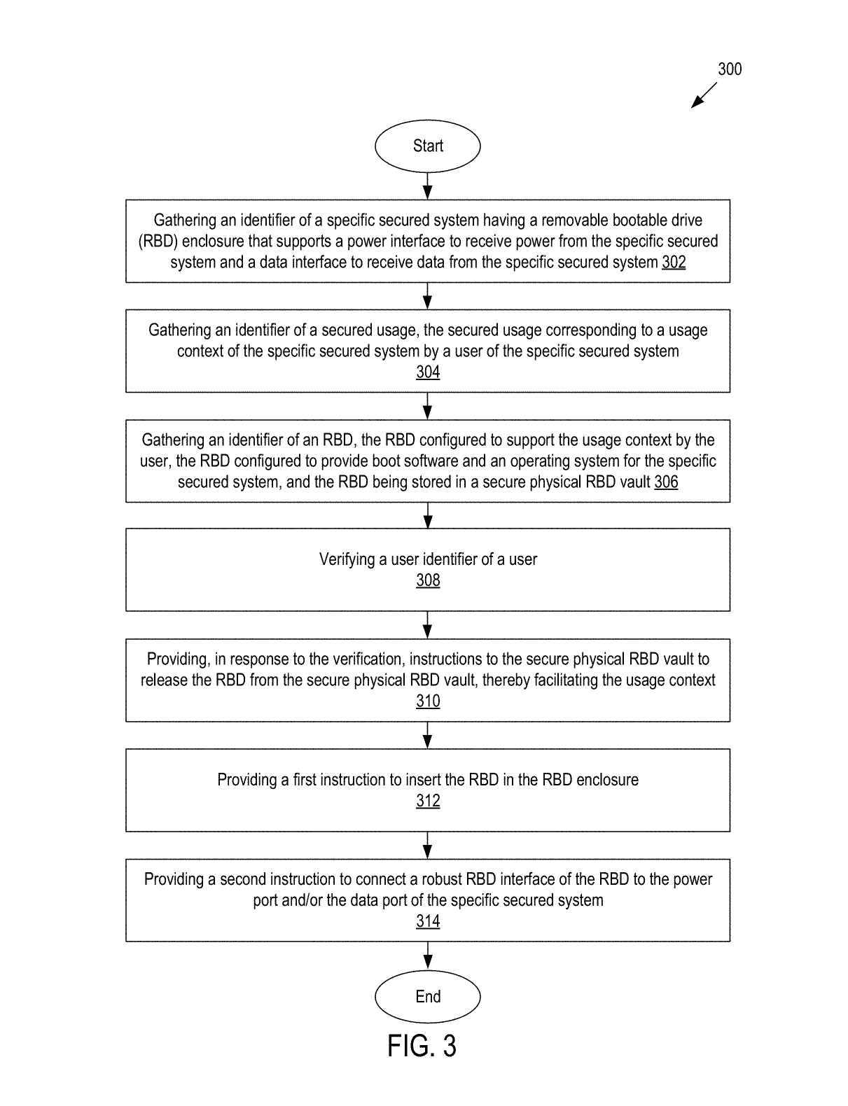

FIG. 3 is a diagram showing a flowchart 300 of an example of a method of using a secure environment containing a secure working area and a secure removable disk (RD) storage area. It is noted the flowchart 300 may have additional or fewer operations and/or modules than those depicted in FIG. 3. It is also noted that the operations of the flowchart 300 need not have the order shown in FIG. 3, and that these operations may be performed in order(s) not shown in FIG. 3, potentially including parallel operation.

At module 302 an identifier of a specific secured system having a removable bootable drive (RBD) enclosure that supports a power interface to receive power from the specific secured system and a data interface to receive data from the specific secured system is gathered. The specific secured system may comprise at least one SFF device or at least one laptop device.

At module 304 an identifier of a secured usage is gathered. In various implementations, the secured usage correspond to a usage context of the specific secured system by a user of the specific secured system.

At module 306, an identifier of an RBD is gathered. In various implementations, the RBD is configured to support the usage context by the user. Additionally, the RBD may be configured to provide boot software and an operating system for a secured device of the specific secured system. In some implementations, the RBD may be stored in a secure physical RBD vault.

At module 308, a user identifier of a user is verified. In some implementations, the user identifier is gathered at a user interface and verified against known user identifiers stored in a datastore.

At module 310 instructions are provided, in response to the verification, to the secure physical RBD vault to release the RBD from the secure physical RBD vault, thereby facilitating the usage context. The instructions may instruct the secure physical RBD vault to physically unlock the RBD to be provided for the usage context.

At module 312, a first instruction to insert the RBD in the RBD enclosure is provided. At module 314, a second instruction to connect a robust RBD interface of the RBD to the power port and/or the data port of a secured device of the specific secured system is provided. These instructions may be displayed on a user interface.

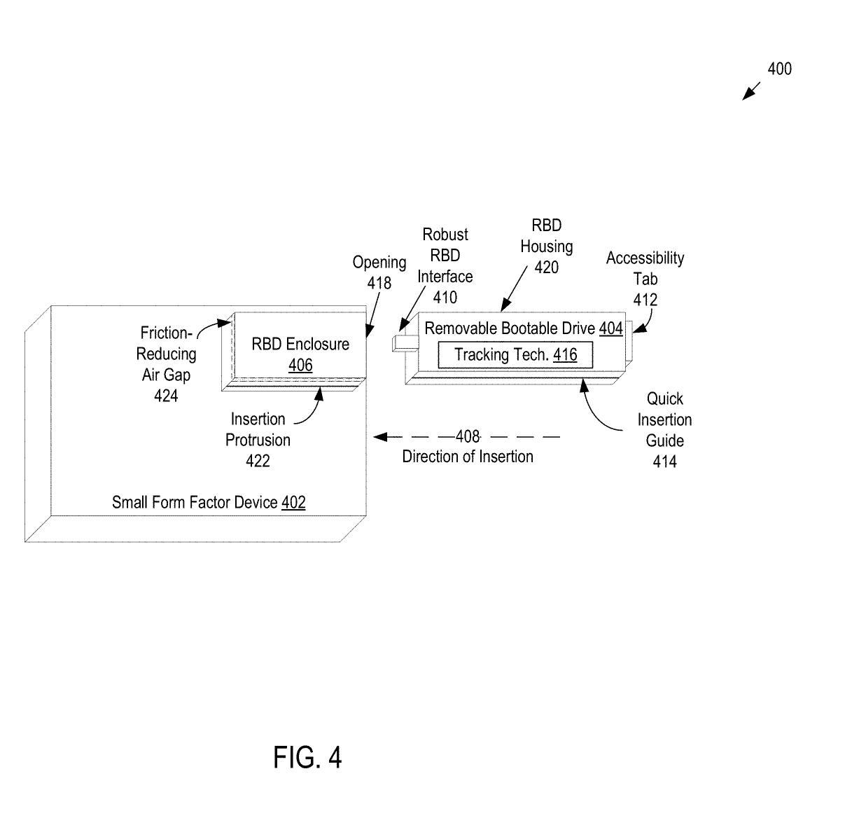

FIG. 4 is a diagram 400 showing an example of an SFF device 402 having an RBD enclosure 406, and capable of being coupled to an RBD 404. In this example, the SFF device 402 includes the RBD enclosure 406 coupled thereto.

In a specific implementation, the RBD 404 includes a storage disk (or other storage device) that provides storage capabilities for the SFF device 402. For example, the RBD 404 may include a hard-disk drive (HDD) having magnetic storage capabilities, a solid state drive (SSD) that is configured to store data on solid state media, or a flash-based solid-state storage device that uses integrated circuit assemblies as memory to store data persistently. The RBD 404 may have a variety of sizes and/or shapes, but in a specific implementation, the RBD 404 has a size and/or shape so that it can be received by the opening 418 of the SFF device 402. As additional examples, the RBD 404 may have a standard form factor of an HDD, a mini-SATA (mSATA) form factor, or a Next Generation Form Factor (NGFF)/M.2 Form Factor. In the example of FIG. 4, the RBD 404 is inserted into the RBD enclosure 406 in a direction of insertion 408.

In the example of FIG. 2, the RBD 404 includes an RBD housing 420 that houses the RBD 404. The RBD housing 420 includes an quick insertion guide 414 that mates with the insertion protrusion 422 on the RBD enclosure 406. The quick insertion guide 414 comprises a groove formed in the RBD enclosure 406 that mates with the insertion protrusion 422.

In some implementations, the RBD 404 includes a secure operating system, secure applications, secure processes, and/or other secure resources that are protected from unauthorized access. The secure operating system, secure applications, secure processes, and/or other secure resources may be protected by encryption, passwords, biometric authentication, or other security techniques. The secure operating system may include secure boot loading software that allows the SFF device 402 to be booted up with the secure operating system. In a specific implementation, it is not possible to boot the SFF device 402 without the secure operating system. The secure applications, secure processes, and/or secure resources may include hardware and/or software that is not accessible by processes executing outside the secure operating system.

In the example of FIG. 4, the RBD 404 includes a robust RBD interface 410 at a first end, an accessibility tab 412 at a second end opposite the first end, and tracking technology 416. In a specific implementation, the RBD 404 is chamfered at the first end to enable faster insertion into the RBD enclosure 406. For example, the RBD 404 may have a symmetric sloping edge that makes the first end narrower than the second end.

The robust RBD interface is intended to represent a device formed of a sturdy material that can withstand repeated use without breakage. For example, the robust RBD interface may be formed of polymethyl methacrylate (PMMA), polycarbonate, or modified PMMA or polycarbonate. In various implementations, the robust RBD interface 410 includes power cables, data cables, and/or other components as discussed in detail herein. The power cables, data cables, and/or other components are operationally coupled to a motherboard of the SFF device 402. In a specific implementation, he robust RBD interface 410 includes components configured to provide power from the SFF device 402 to the RBD 404. In a specific implementation, the robust RBD interface 410 includes components configured to transfer data between the SFF device 402 and the RBD 404.

The accessibility tab 412 is intended to represent a device that facilitates insertion of the RBD 404 into or remove the RBD 404 from the RBD enclosure 406 by a user. In various implementations, the accessibility tab 412 includes ridges, indentations, and/or other surface formations that allow a person to grip the accessibility tab 412. In a specific implementation, the accessibility tab 412 has a specific color to assist in visually identifying the RBD 404 for security purposes.

The tracking technology 416 is intended to represent components to facilitate identifying locations and/or configurations of the RBD 404. In various implementations, the tracking technology 416 is formed of radio opaque identifiers that are visible only upon a radio scan, radio frequency (RF) tracking technology, etc., as discussed further herein.

The RBD enclosure 406 is intended to represent an enclosure configured to receive the RBD 404. In various implementations, the RBD enclosure 406 is mounted at various locations over the SFF device 402. In a specific implementation, the RBD enclosure 406 is mounted on a personal computer (PC) bezel of the SFF device 402. For example, the PC bezel may be adjacent to an optical disc drive (not shown) mounted on the SFF device 402.

In the example of FIG. 4, the RBD enclosure 406 forms an opening 418 to receive the RBD 404. In various implementations, the opening 418 has a size and a shape compatible with a corresponding size and shape of the RBD 404. For example, the opening 418 may comprise a rectangular opening having a length, width, and depth substantially similar to a corresponding length, width, and depth of the RBD 404.

In the example of FIG. 4, the RBD enclosure 406 includes a friction-reducing air gap 424 along one of its walls. In a specific implementation, the friction-reducing air gap 424 creates space between a wall of the RBD housing 420 and the wall of the RBD enclosure 406 such that the RBD 404 can be inserted into the RBD enclosure 406 easily and/or with reduced friction.

In the example of FIG. 4, the RBD enclosure 406 includes an insertion protrusion 422 formed on one of its walls and/or edges. In a specific implementation, the insertion protrusion 422 is configured to mate with the quick insertion guide 414 of the RBD housing 420.

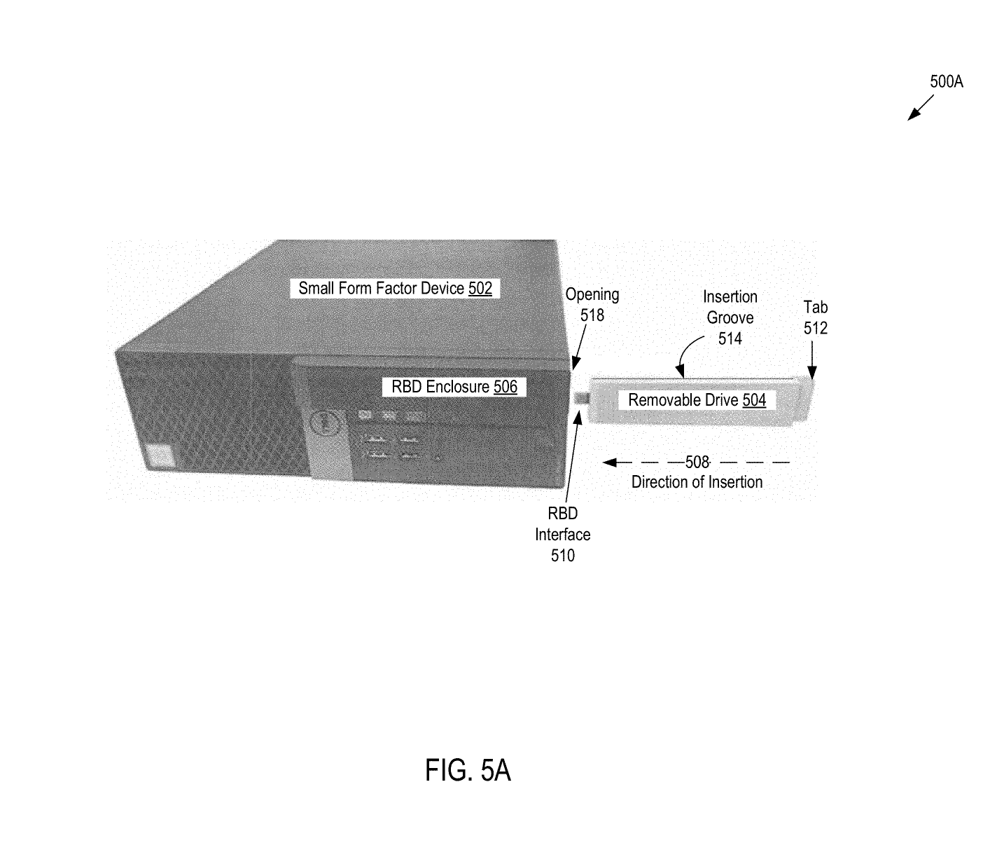

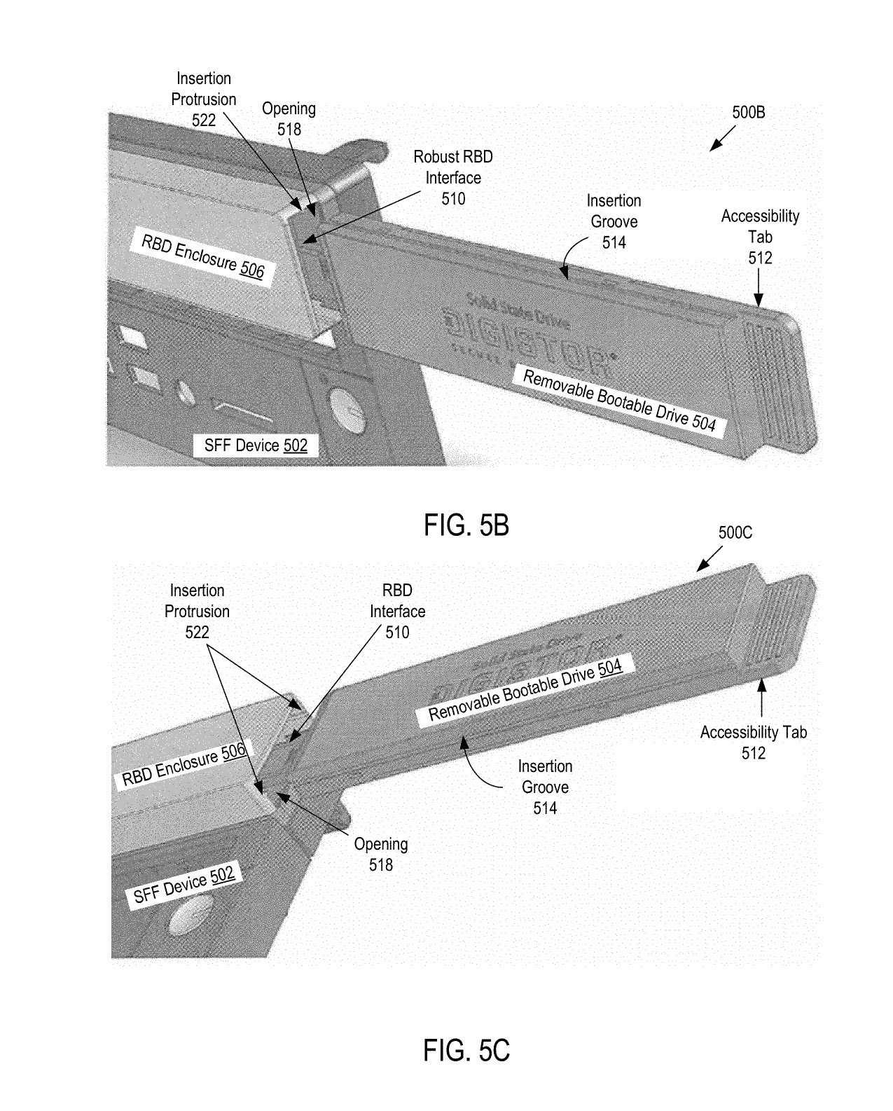

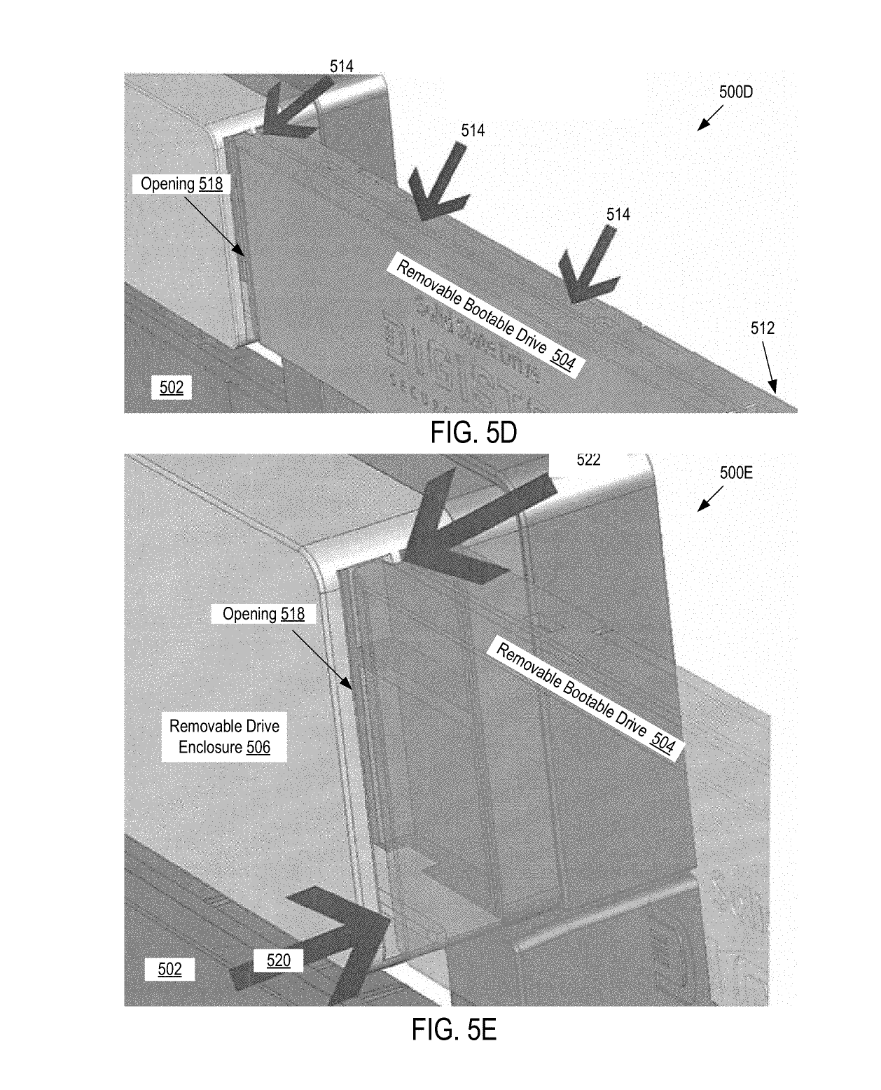

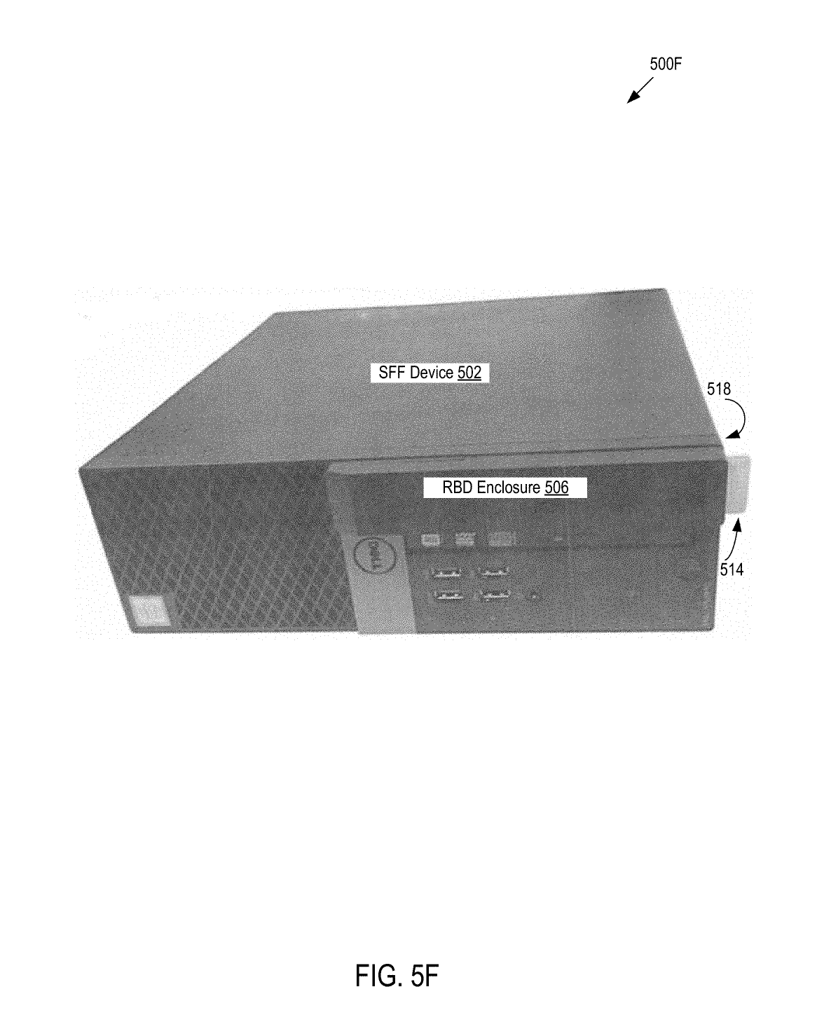

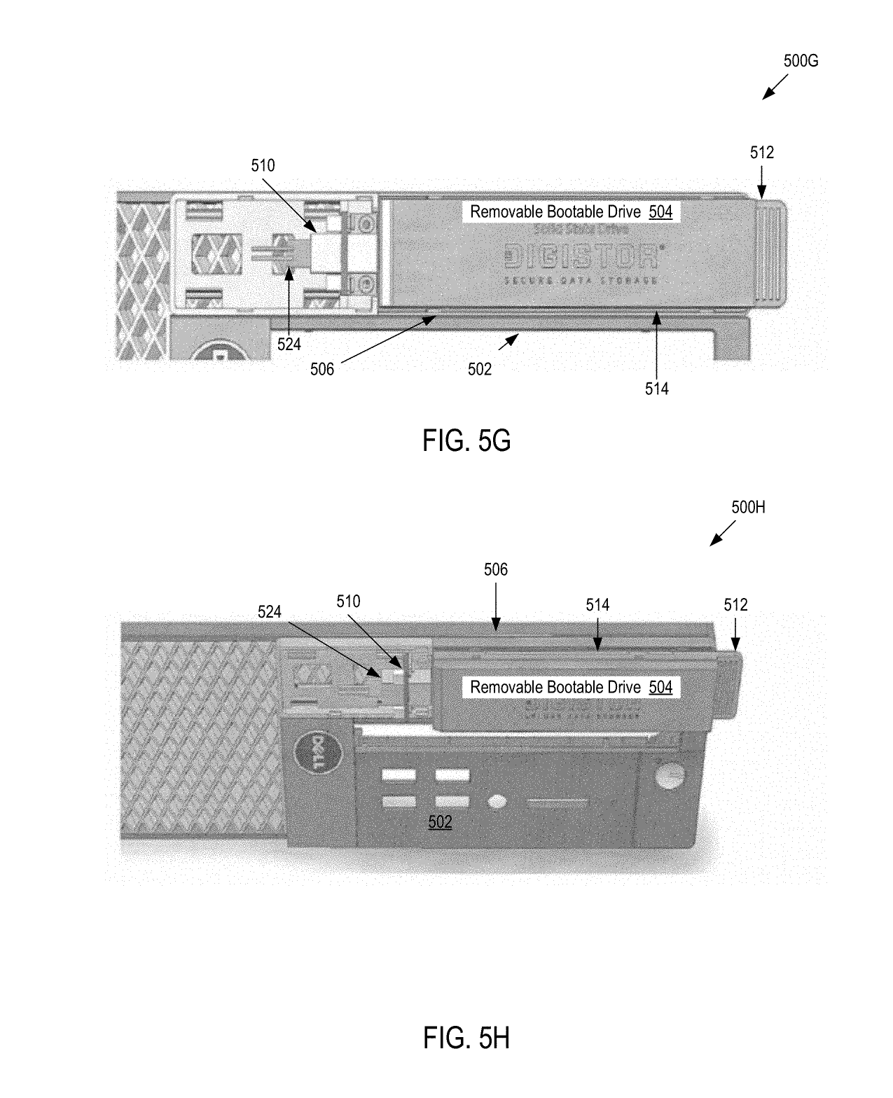

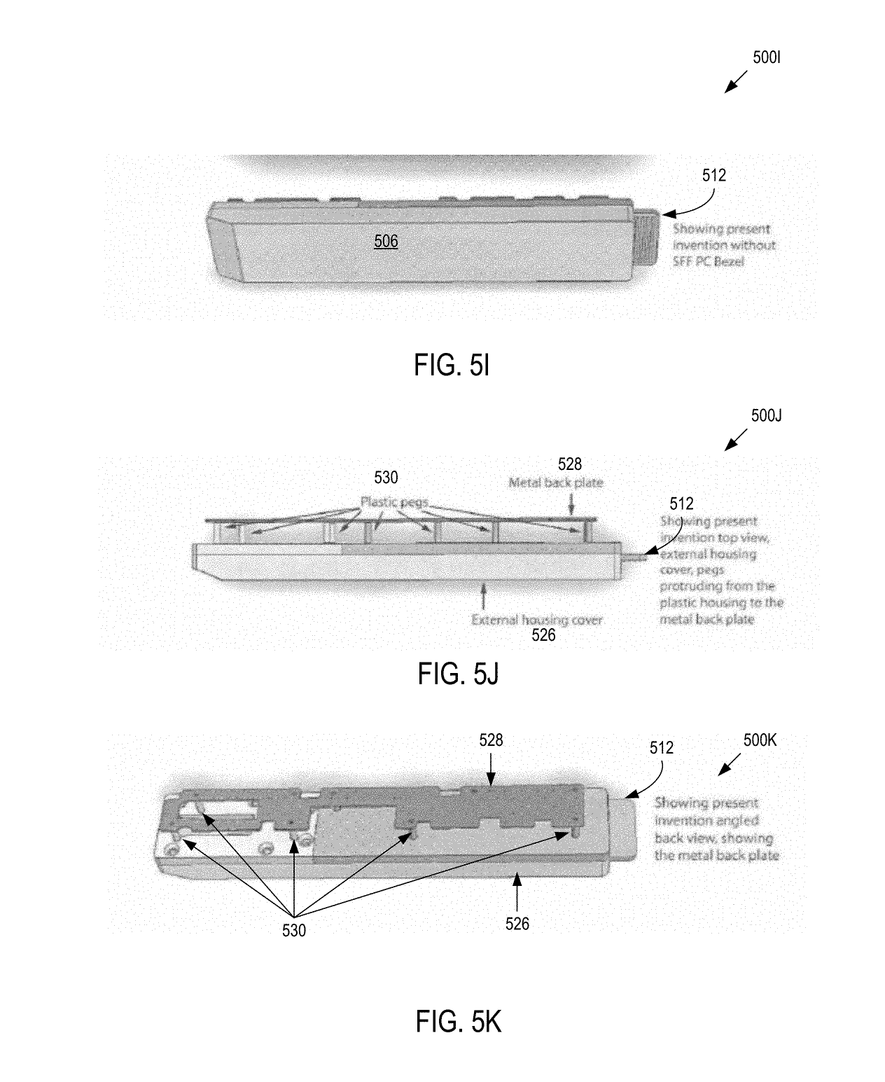

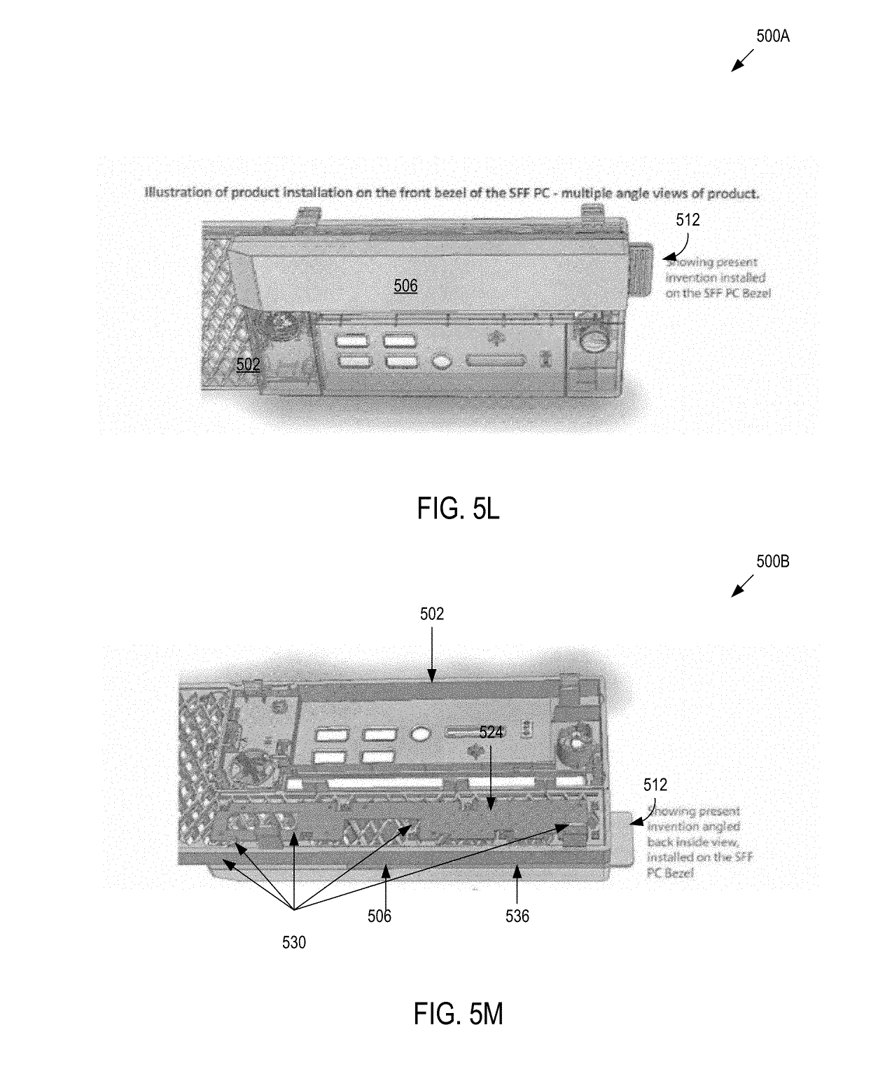

FIGS. 5A-5M are diagrams 500A-500M showing an example of a small form factor (SFF) device 502 having an RBD enclosure 506, and an RBD 504 that can be inserted into the RBD enclosure 506. The diagrams provide different views of the SFF device 502 and RBD 504.

FIG. 5A shows a diagram 500A of an example SFF device 502 having an RBD enclosure 506, and an RBD 504 that can be inserted into the RBD enclosure 506. In the example of FIG. 5A, the RBD 504 has not yet been inserted into the opening 518 of the RBD enclosure 506. The RBD 504 will be inserted into the opening 518 in accordance with the direction of insertion 508. The illustrated RBD 504 includes a solid state drive (SSD) (not shown), a secure operating system, secure applications, and secure processes. The secure operating system includes secure boot loading software that allows the SFF device 502 to be booted up with the secure operating system.

The illustrated RBD 504 has a size and shape enabling the RBD 504 to fit in the opening 518 of the SFF device 502. The example of FIG. 5A further shows the robust RBD interface 510 at a first end and the accessibility tab 512 at a second end opposite the first end of the RBD 504. As noted herein, once the RBD 504 has been inserted into the RBD enclosure 506, the robust RBD interface 510 may connect to power and/or data circuitry of the SFF device 502, and may, accordingly, draw power and transfer data to/from the SFF device 502.

The diagram 500A is intended to illustrate the RBD enclosure 506 is mounted on the SFF device 502 on a PC bezel. In the illustration, the PC bezel is adjacent to an optical disc drive (not shown) mounted on the SFF device 502. The RBD enclosure 506 forms an opening 518 to receive the RBD 504. The opening 518 has a size and a shape compatible with a corresponding size and shape of the RBD 504; in this illustration the opening 518 comprises a rectangular opening having a length, width, and depth substantially similar to a corresponding length, width, and depth of the RBD 504.

The diagrams 500B and 500C are intended to illustrate the RBD 504 being inserted into the RBD enclosure 506. The example of FIG. 5B depicts a top view of the SFF device 502 and the RBD 504, while the example of FIG. 5C depicts a bottom view of the SFF device 502 and the RBD 504. In the diagrams 500B and 500C, the RBD 504 is being inserted into the opening 518 of the RBD enclosure 506. The robust RBD interface 510 is to connect to power and/or data circuitry of the SFF device 502.

The diagrams 500D and 500E are intended to illustrate that the RBD enclosure 506 includes an opening 518 to receive the RBD 504. The RBD 504 includes a accessibility tab 512 to facilitate identification of the RBD 504 while inside the opening 518 and/or to allow the RBD 504 to enter or exit the opening 518. In the example of FIG. 5D, the RBD 504 includes an insertion groove 514 that can mate with a corresponding insertion protrusion 522 on the RBD enclosure 506. The insertion groove 514 and the insertion protrusion 522 may allow the RBD 504 to be secured to the walls of the opening 518 when the RBD 504 is inside the RBD enclosure 506. Additionally, the opening 518 may contain an air gap 520 that separates a wall of the RBD 504 from a wall of the opening 518 so that the RBD 504 and the opening 518 do not rub against one another. The air gap 520 may also assist in controlling operating temperatures and/or vibrations of the RBD 504 while the RBD 504 is in the RBD enclosure 506.

The diagram 500F is intended to illustrate that the RBD enclosure 506 resides over a motherboard (not shown) of the SFF device 502. Additionally, in this example, the accessibility tab 512 contains ridges that allow a person to insert the RBD 504 into or remove the RBD 504 from the RBD enclosure 506 using the person's thumb and forefingers. In this example, the accessibility tab 512 is formed of rigid plastic. In this example, the RBD 504 has been inserted into the opening 518 of the RBD enclosure 506.

The diagrams 500G and 500H depict cross-sectional views of the SFF device 502, the RBD enclosure 506, and the RBD 504. In the example of FIG. 5G, the RBD 504 has been inserted into the RBD enclosure 506, and the air gap 520 separating a wall of the RBD 504 from a wall of the RBD enclosure 506 is shown. In the example of FIG. 5H, the insertion groove 514 is shown. In the examples of FIG. 5G and 5H, the robust RBD interface 510 is connected to a port 524 that supplies power and/or data to the RBD 504 through the robust RBD interface 510.

The examples of FIGS. 5I, 5J, and 5K show the RBD enclosure 506 before it has been mounted on, e.g., bezel of the SFF device 502. The example of FIG. 5I shows the RBD enclosure 506 and the RBD 504. The accessibility tab 512 is visible in this example. The example of FIG. 5J further shows an external housing cover 526 to cover the RBD enclosure 506, and a back plate 528. In an implementation, the back plate 528 is made of metal or other conductive material to support an electrical connection for a removable disk inserted in the RBD enclosure 506, and pegs 530 for mounting the RBD enclosure 506 to the SFF device 502. In a specific implementations, the pegs 530 are made of plastic or other nonconductive materials in order to reduce electrical interference with the SFF device 502 or the RBD 504. The example of FIG. 5K shows an angled back view and further illustrates the back plate 528.

The diagrams 500L and 500M are intended to illustrate how the RBD enclosure 506 is installed over a PC bezel of the SFF device 502. The diagram 500L shows a front view, while the diagram 500M shows a rear view. The example of FIG. 5M further shows a backplane 536 that supplies electrical connectivity to an RBD 504 through the SFF device 502.

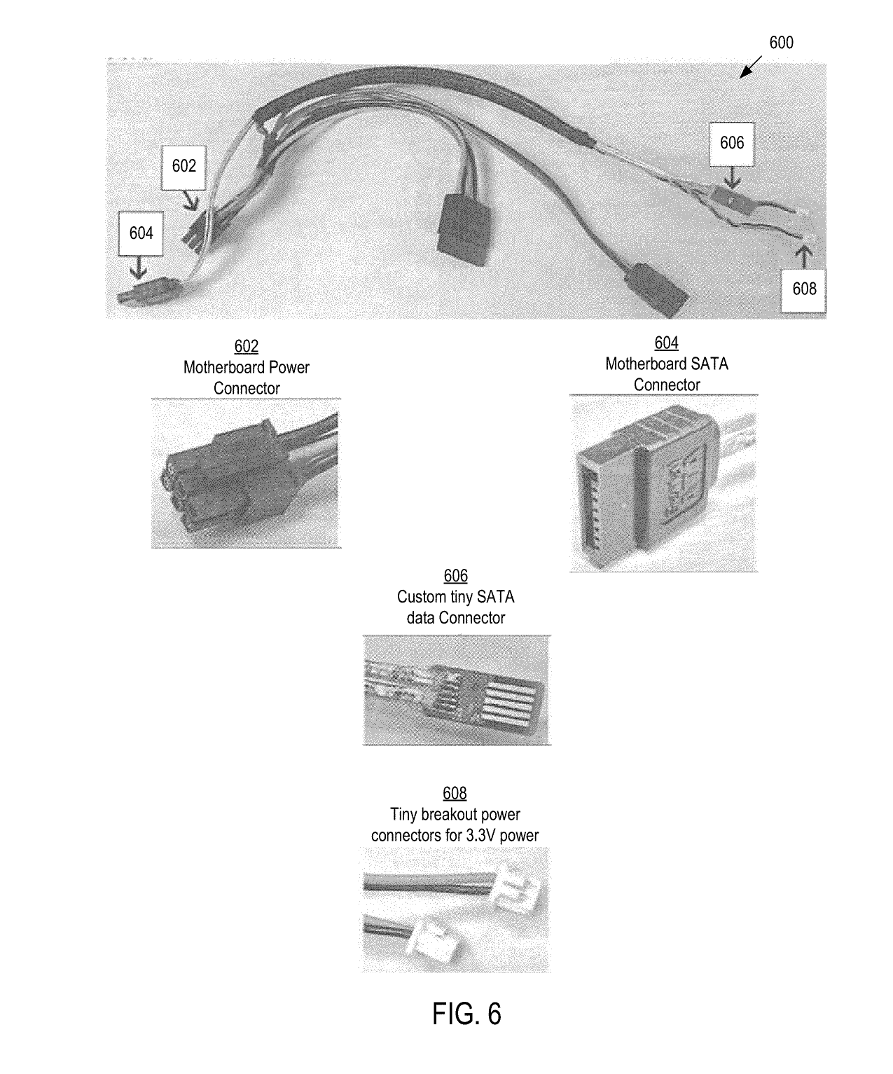

FIG. 6 is a diagram 600 showing examples of components of a removable disk interface used to couple a removable disk to an SFF device. The example of FIG. 6 shows a motherboard power connector 602, a motherboard SATA connector 604, a customized SATA data connector 606, and a breakout power connector 608. In some implementations, the wires coupling the motherboard power connector 602, the motherboard SATA connector 604, the customized SATA data connector 606 and the breakout power connector 608 are wired through an RBD enclosure in order to supply power and/or data between an SFF device and an RBD. The motherboard power connector 602 and motherboard SATA connector 604 may connect to a motherboard of an SFF device. The customized SATA data connector 606 and the breakout power connector 608 may connect to appropriate parts of an RBD. Advantageously, the customized SATA data connector 606 can fit into relatively small openings in preexisting SFF device housings.

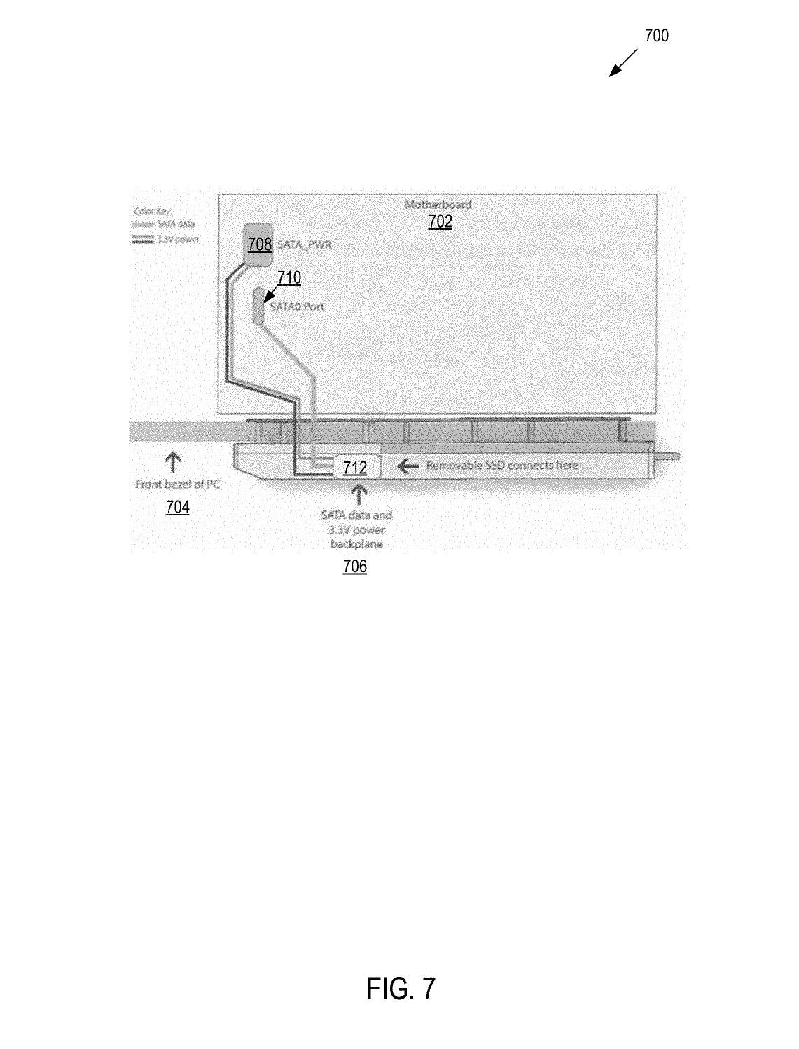

FIG. 7 is a diagram 700 showing an example of how a removable disk interface may connect to an SFF device. Shown in the diagram 700 are a motherboard 702, a front bezel 704, and a backplane 706. Also shown are a SATA power port 708, a SATA port 710, and an RBD enclosure 712. In this example, the RBD enclosure 712 resides below the front bezel 704. The RBD enclosure 712 may receive an RBD. The RBD may draw power at 3.3 V and data from the SATA power port 708. The RBD may draw data from the SATA port 710.

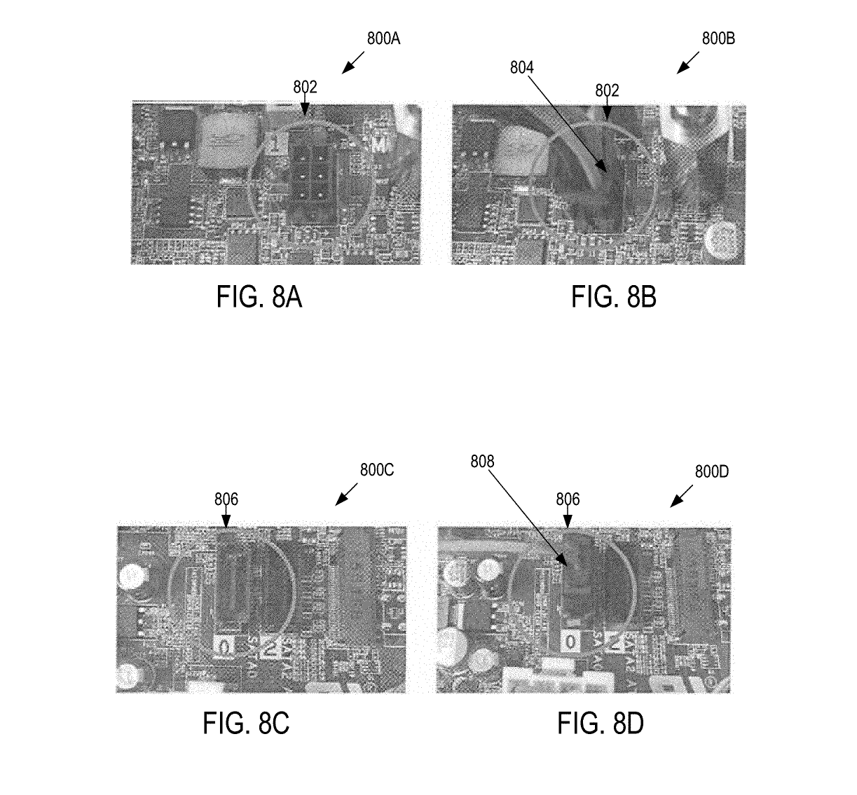

FIGS. 8A-8D are diagrams 800A, 800B, 800C, and 800D showing examples of how a removable disk interface may connect to an SFF device. These examples show a power connector 802, a power cable 804, a data connector 806, and a data cable 808. In the example of FIGS. 8A and 8B, the power cable 804 is being coupled to the power connector 802 so that an RBD can be connected to a motherboard and draw power from the motherboard. In the example of FIGS. 8C and 8B, the data cable 808 is being coupled to the data connector 806, so that the RBD can be connected to the motherboard and send data to/receive data from the motherboard.

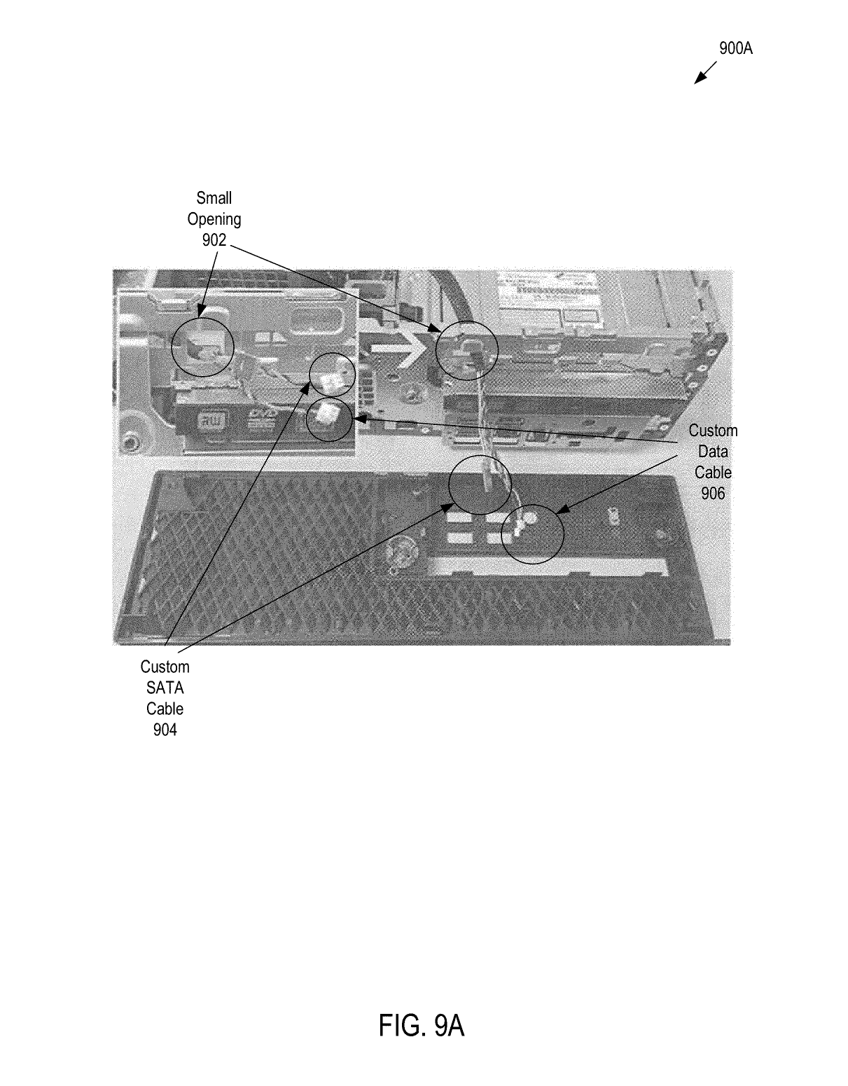

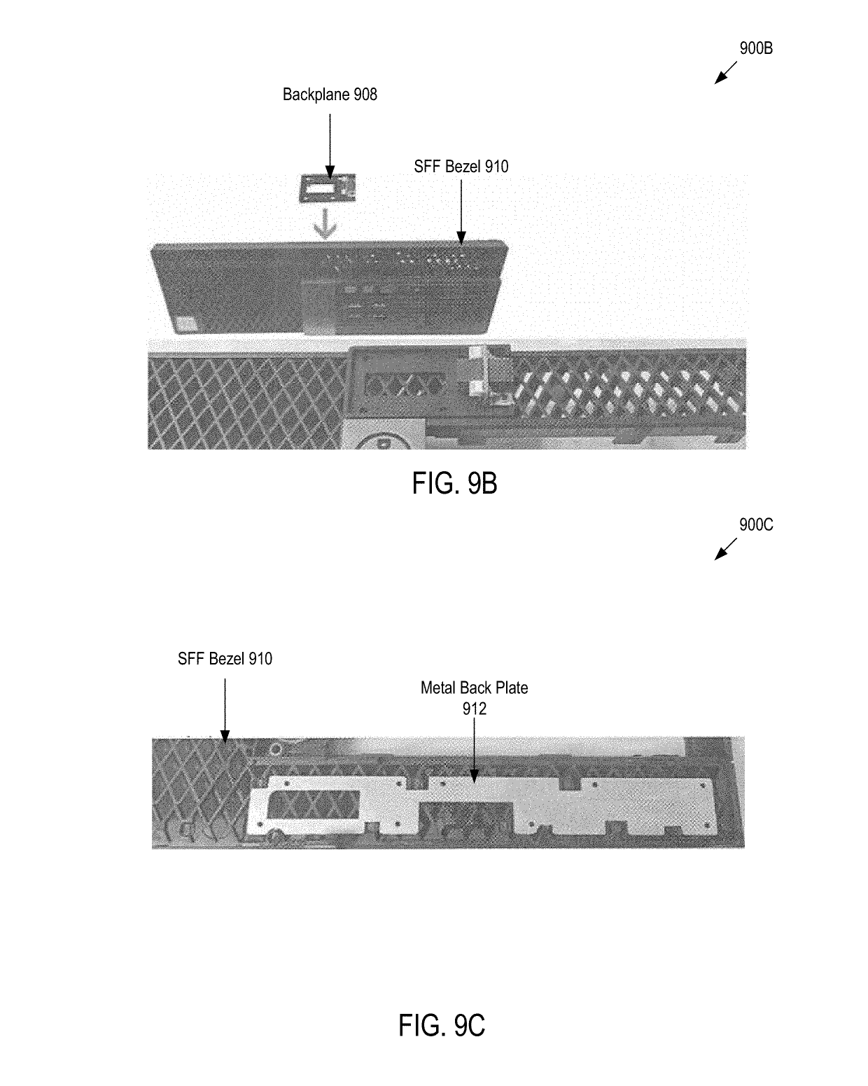

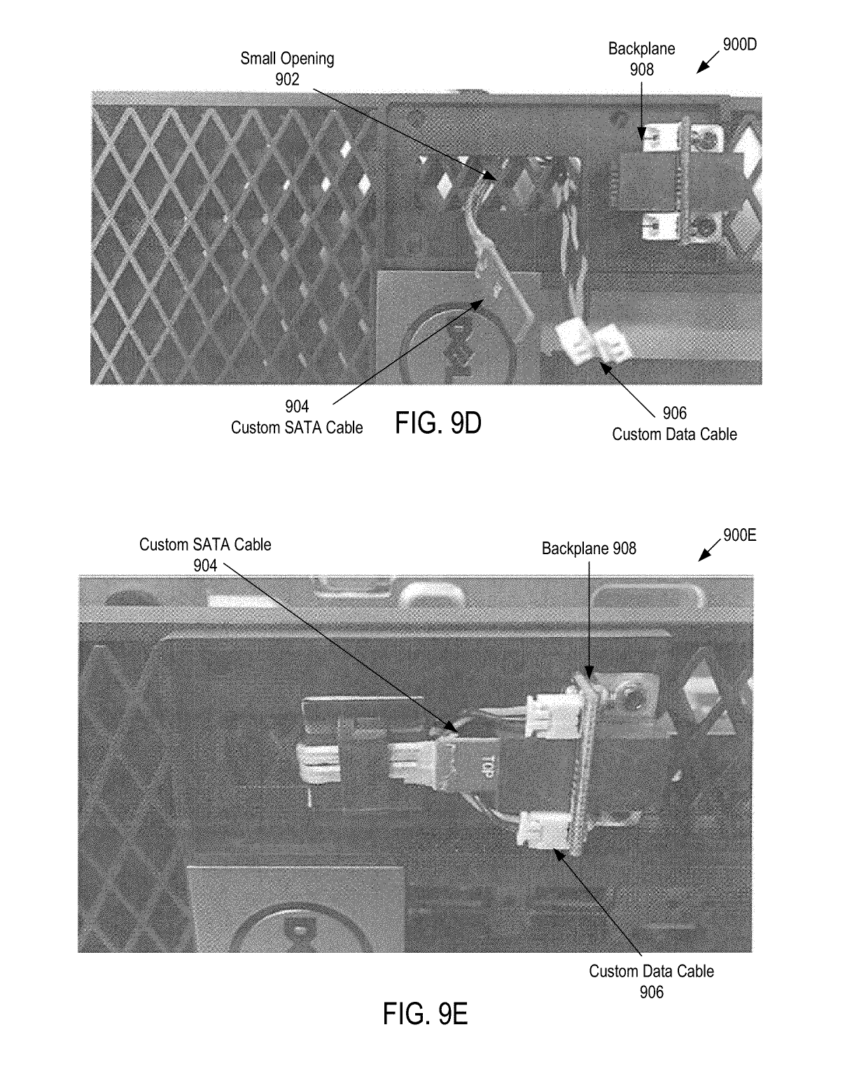

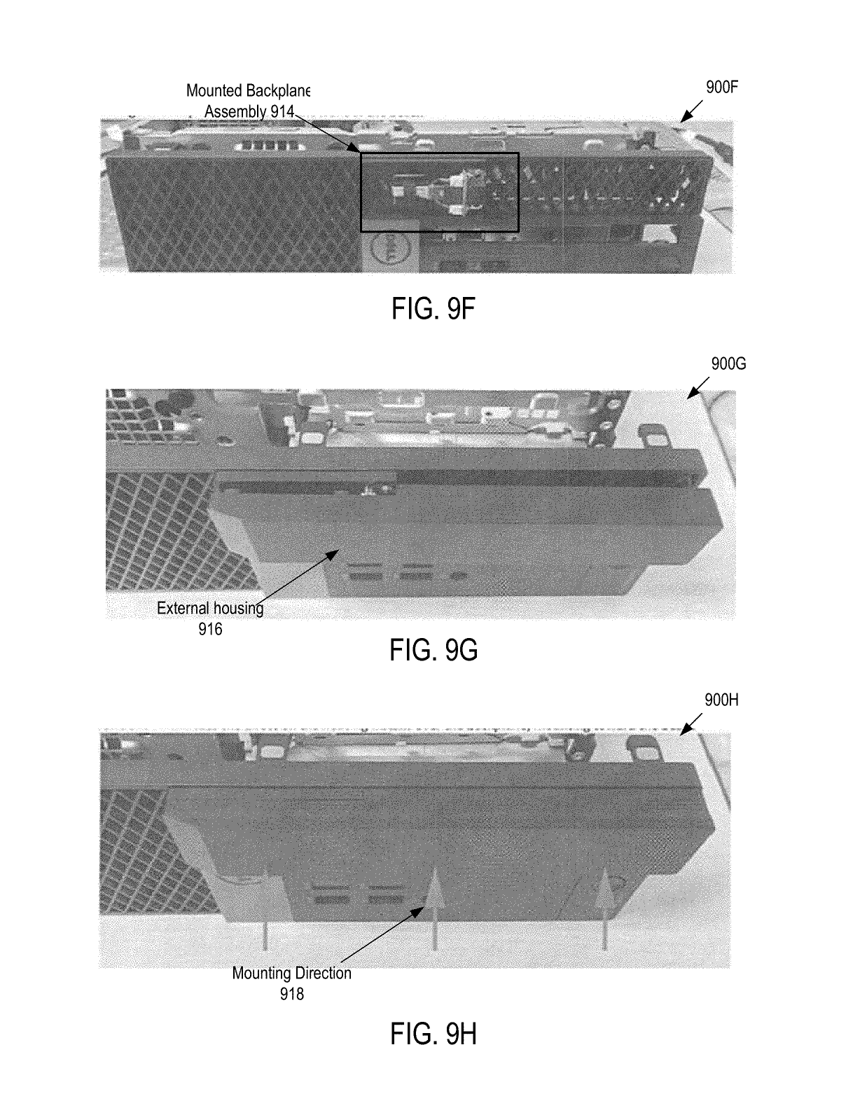

FIGS. 9A-9H are diagrams 900A-900H showing examples of how an RBD may be connected to an SFF device. In the example of FIG. 9A, a small opening 902 may receive a custom SATA cable 904 and a custom data cable 906. The custom SATA cable 904 and the custom data cable 906 may be coupled to corresponding portions of an RBD to facilitate transfer of power and/or data thereto. The small opening 902 may be part of the front of an SFF device. The custom SATA cable 904 and the custom data cable 906 may pass through the small opening 902. The example of FIG. 9B shows a backplane 908 being connected to an SFF bezel 910. As noted herein, the backplane 908 may installed on the SFF bezel 910.

The example of FIG. 9C shows the SFF bezel 910 and a metal back plate 912. The metal back plate 912 may provide an electrical back plate for items coupled thereto. The example of FIG. 9C shows a rear view in which screws hold the backplane 908 in place on the front of the SFF bezel 910. The example of FIG. 9D shows a front view where the custom SATA cable 904 and the custom data cable 906 have been pulled through the small opening 902. Also shown in FIG. 9D is the backplane 908. In the example of FIG. 9E, the custom SATA cable 904 and the custom data cable 906 have been coupled to the backplane 908. As a result, the custom SATA cable 904 and the custom data cable 906 may provide and/or data to an RBD through the backplane 908. The example of FIG. 9F shows a mounted backplane assembly 914, which may correspond to the areas shown in FIG. 9E. In the example of FIGS. 9G and 9H, an external housing 916 has been mounted over the mounted backplane assembly 914 in a mounting direction 918.

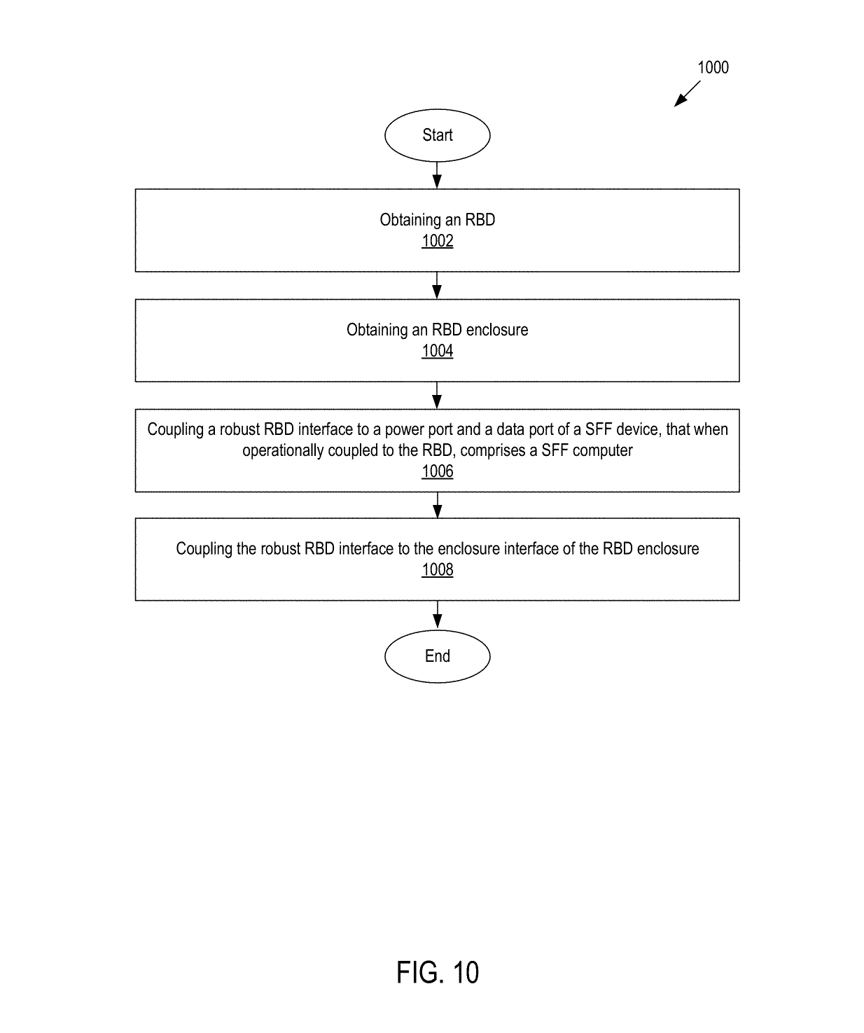

FIG. 10 is a diagram showing a flowchart 1000 of an example of a method of using an SFF device and an RBD. The method may be performed by one or more of the structures discussed in this paper. At module 1002, an RBD may be obtained. At module 1004, an RBD enclosure may be obtained. At module 1006, a robust RBD interface of the RBD may be coupled to a power port and a data port of an SFF device, that, when coupled to the RBD, comprise an SFF computer (e.g., with memory and processor(s)). At module 1008, the robust RBD interface may be coupled to an enclosure interface of the RBD enclosure.

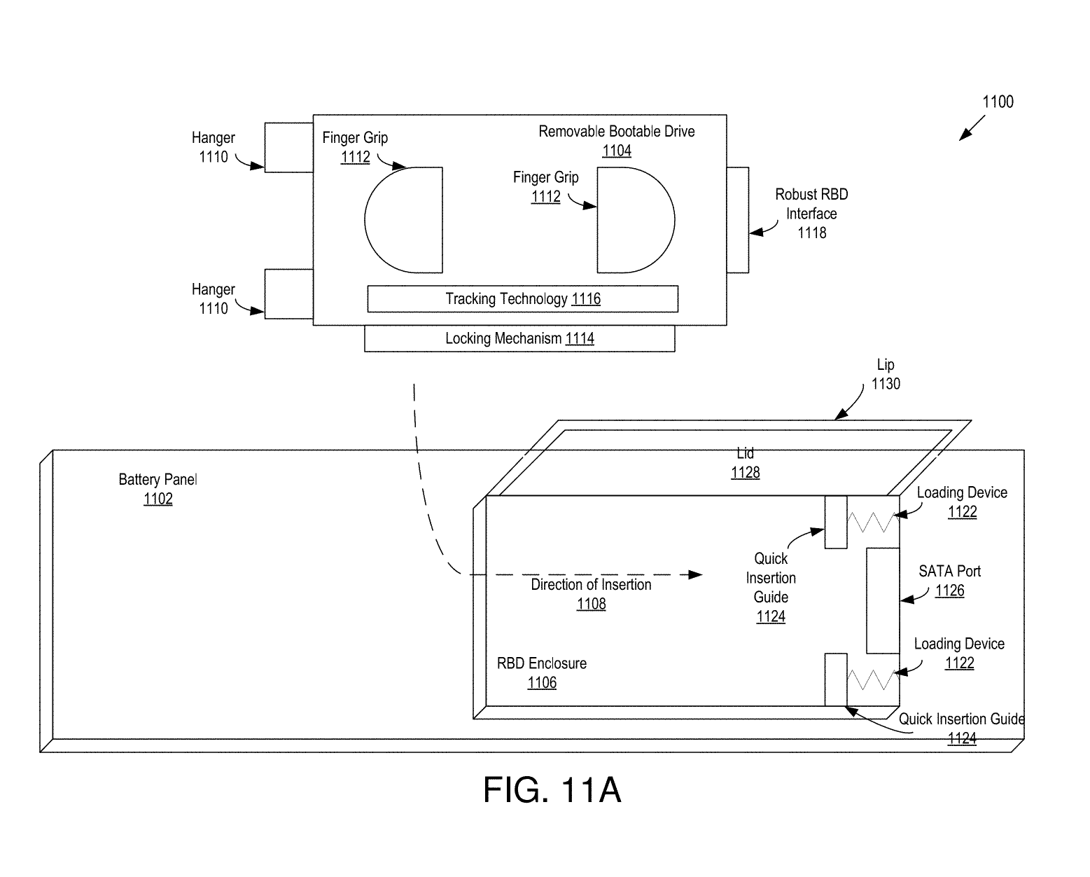

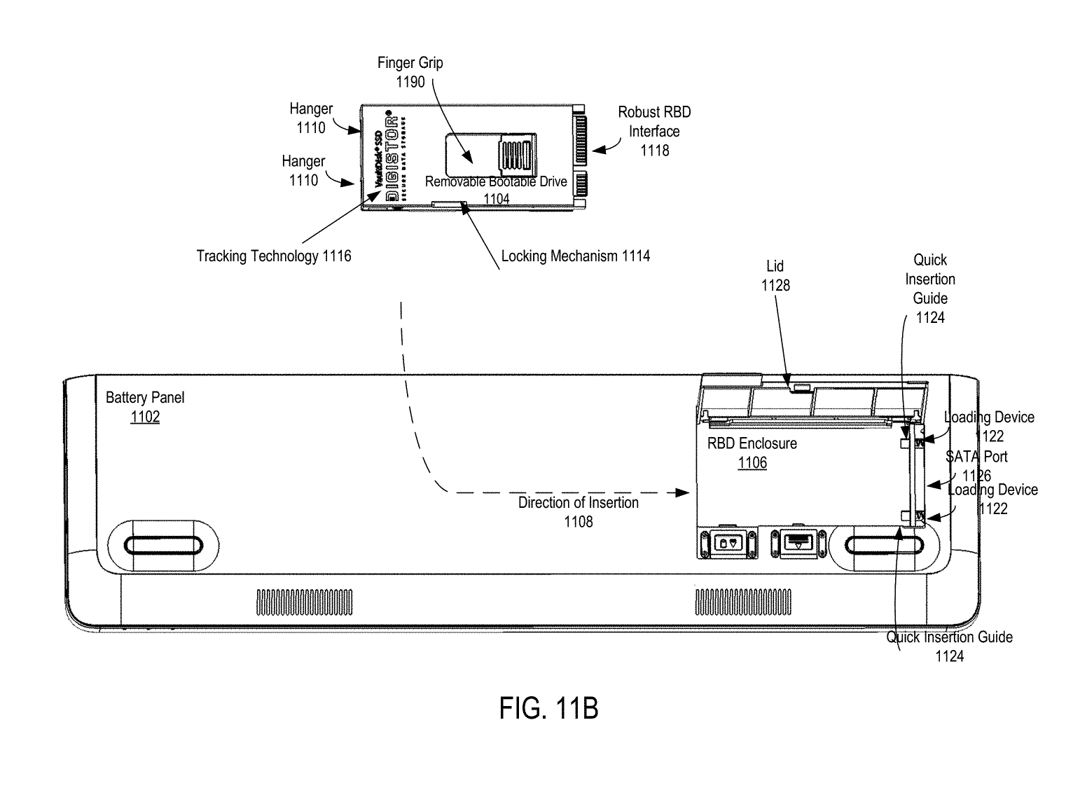

FIG. 11A is a diagram 1100A showing an example of a laptop device having battery panel 1102 with an RBD enclosure 1106, and capable of being coupled to an RBD 1104. In the example of FIG. 11A, the RBD 1104 includes one or more hanger(s) 1110, one or more finger grip(s) 1112, an locking mechanism 1114, tracking technology 1116, and a robust RBD interface 1118. In this example, the RBD enclosure 1106 is formed in the battery panel 1102. The RBD enclosure 1106 may include one or more loading device(s) 1122, a quick insertion guide 1124, a SATA port 1126, and a lid 1128. The lid 1128 may include a lip 1130.

In a specific implementation, the RBD 1104 includes an RBD housing that is configured to house RBD storage. The RBD housing may include a rigid body having a size and/or a shaped configured to house a storage drive, e.g., an SSD. As noted herein, the storage drive may include boot software and/or an operating system that allows the laptop computer to be booted and/or operate in accordance with the operating system. In some implementations, the RBD housing protects the RBD storage from external pressures and/or forces. The RBD housing may be formed from a rigid plastic. The RBD housing may have a size and a shape corresponding to a size and a shape of the RBD enclosure 1106. In some implementations, the RBD housing has a width corresponding to a width of the RBD enclosure 1106 and a length corresponding to a length of the RBD enclosure 1106 minus a length of the SATA port 1126. In various implementations, the RBD housing is sized and/or shaped so that the robust RBD interface 1118 is electrically coupled to the SATA port 1126 when the RBD 1104 is inserted into the RBD enclosure 1106.

In various implementations, the hanger(s) 1110 comprise one or more physical components that can be coupled to a sidewall of the RBD enclosure 1106. In some implementations, the hanger(s) 110 are attached to a rear sidewall of the RBD enclosure 1106 (e.g., a sidewall opposing the SATA port 1126). The hanger(s) 1110 may comprise hooks that couple the rear wall of the RBD 1104 to the rear wall of the RBD enclosure 1106. Though FIG. 11A shows the hanger(s) 1110 on the rear wall of the RBD 1104, it is noted that in some implementations, the hanger(s) 1110 reside on other sidewalls of the RBD 1104 to facilitate coupling to other sidewalls of the RBD enclosure 1106. Further, though FIG. 11A shows the element 1110 as “hanger(s), it is noted that in some implementations, the element 1110 may designate other coupling and/or balancing mechanisms, such as adhesive, screws, springs, etc.

In various implementations, the finger grip(s) 1112 comprise one or more indentations on a top surface of the RBD 1104 configured to facilitate grip, transport, and/or handling of the RBD 1104. The finger grip(s) 1112 make up accessibility indentations that provide a useful grip for a user to insert the RBD 1104 into the RBD enclosure 1106 and to couple the robust RBD interface 1118 with the SATA port 1126. In some implementations, the finger grip(s) 1112 are sized and/or shaped to correspond to the size of the tip of a human finger. A user may insert two finger tips (e.g., thumb tip and forefinger tip) into the finger grip(s) 1112 and may exert a force along a parallel axis between the finger grip(s) 1112. The force may provide the basis of a grip used to handle the RBD 1104.

In various implementations, the locking mechanism 1114 comprises one or more physical components to allow the RBD 1104 to be locked into or unlocked from a resting position in the RBD enclosure 1106. In some implementations, the locking mechanism 1114 comprises a spring-based lock that is biased when the RBD 1104 has been inserted into the RBD enclosure 1106 and is resting therein. The locking mechanism 1114 may also comprise a button that allows the spring-based lock to be de-biased when the button is pressed. In various implementations, the locking mechanism 1114 rests along a sidewall of the RBD enclosure 1106 when the RBD 1104 has been placed in a resting position in the RBD enclosure 1106.

In various implementations, the tracking technology 1116 includes one or more physical components to facilitate identifying locations and/or configurations of the RBD 1104. The tracking technology 1116 may be formed of radio opaque identifiers that are visible only upon a radio scan, radio frequency (RF) tracking technology, etc., as discussed further herein.

In various implementations, the robust RBD interface 1118 includes power cables, data cables, and/or other components as discussed in detail herein. The power cables, data cables, and/or other components may be coupled to a motherboard of the laptop device containing the battery panel 1102. The robust RBD interface 1118 may include components configured to provide power from the laptop device to the RBD 1104. The robust RBD interface 1118 may also include components configured to transfer data between the laptop device to the RBD 1104.

In various implementations, the loading device(s) 1122 comprise one or more physical components configured to be biased with the RBD 1104. The loading device(s) 1122 may comprise a spring or other biasing mechanism. The loading device(s) 1122 may be coupled to the quick insertion guide(s) 1124, which in turn, may receive a front end of the RBD 1104. The SATA port 1126 may comprise power and/or data ports of the laptop computer. The SATA port 1126 may be configured to receive and be coupled to the robust RBD interface 1118.

In a specific implementation, the lid 1128 is configured to enclose the RBD 1104 when the RBD 1104 has been inserted into the RBD enclosure 1106. The lid 1128 may comprise a planar surface and a lip 1130. The lip 1130 may be inserted alongside and/or inside the sidewalls of the RBD enclosure 1106 when the lid 1128 has been closed.

In various implementations, the RBD 1104 operates to be inserted in the RBD enclosure 1106 in accordance with a direction of insertion 1108. More particularly, a user may grip the RBD 1104 using the finger grip(s) 1112 by inserting a thumb tip, forefinger tip, or tip of other finger into the finger grip(s) 1112. The user may align the hanger(s) 1110 with appropriate sidewalls of the RBD enclosure 1106. The user may also align the robust RBD interface 1118 with the SATA port 1126 and the front walls of the RBD 1104 with the quick insertion guide(s) 1124. The user may insert the RBD 1104 into the RBD enclosure 1106 along the direction of insertion 1108. Once the user has mated the robust RBD interface 1118 with the SATA port 1126, the user may bias the loading device(s) 1122 by exerting a force against them with the front sidewalls of the RBD 1104. The user may further activate the locking mechanism 1114 once the loading device(s) 1122. The user may use the tracking technology 1116 to track the RBD 1104 as discussed further herein. Once inserted, the RBD 1104 may draw power and/or data from the laptop device through the SATA port 1126, and correspondingly, through the robust RBD interface 1118.

FIG. 11B is a diagram 1100B showing an example of a laptop device having battery panel 1102 with an RBD enclosure 1106, and capable of being coupled to an RBD 1104. In the example of FIG. 11B, a single finger grip 1190 (instead of the plurality of finger grips 1112 shown in FIG. 11A) is shown on the RBD 1104. The finger grips 1112 may be designed with non-movable bridge top for grip. They may be yellow in color. They The finger grip 1190 may be designed for flip up handle to grab for inserting or removing the RBD 1104. The finger grip 1190 may be suitable for mass production. The finger grip 1190 may be 9.5 mm in height for use with an adapter frame as a backwards compatible SSD drive. It may be gray in color with a light gray colored flip up handle.

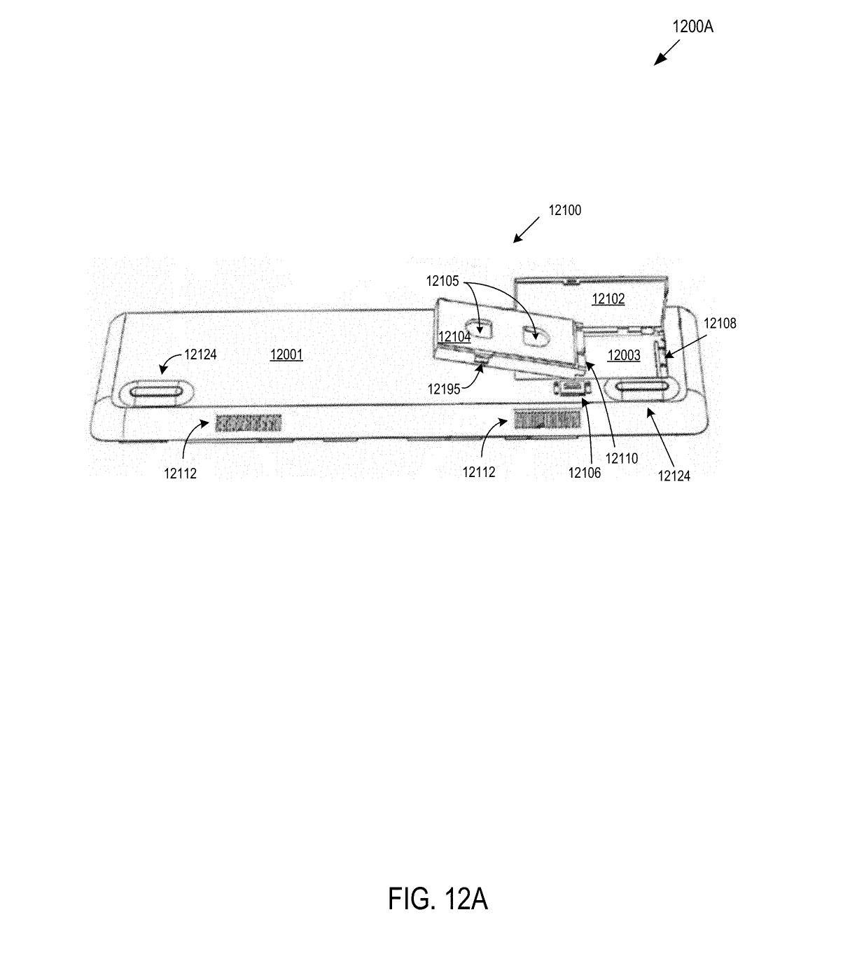

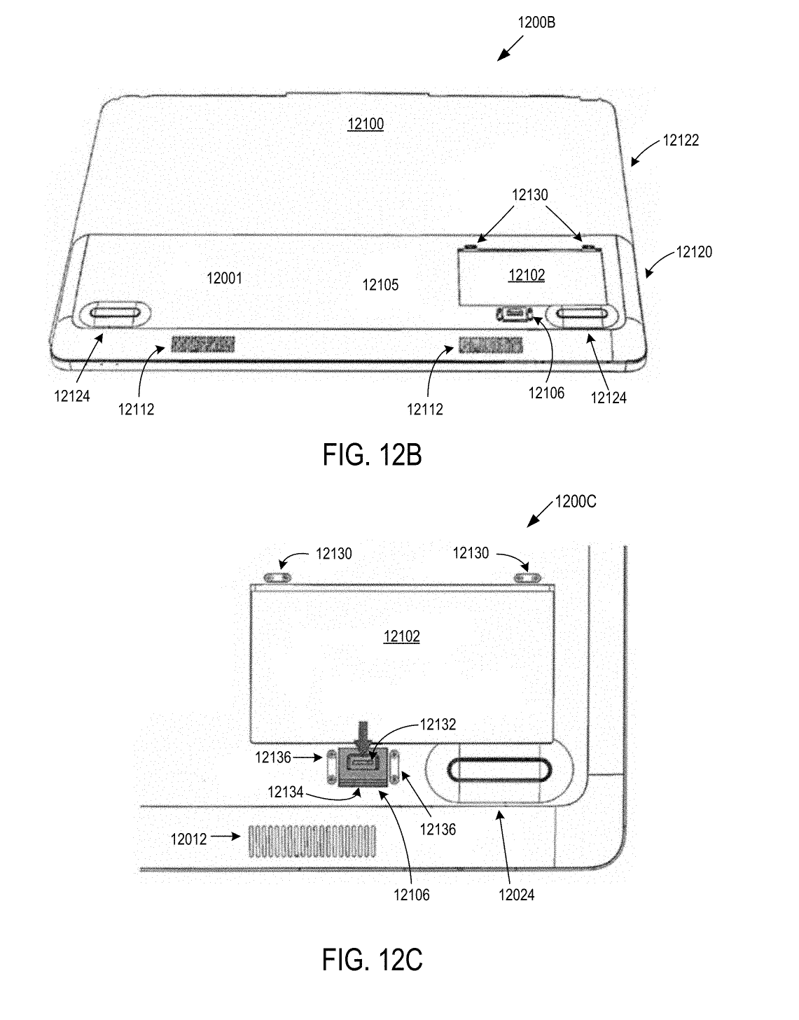

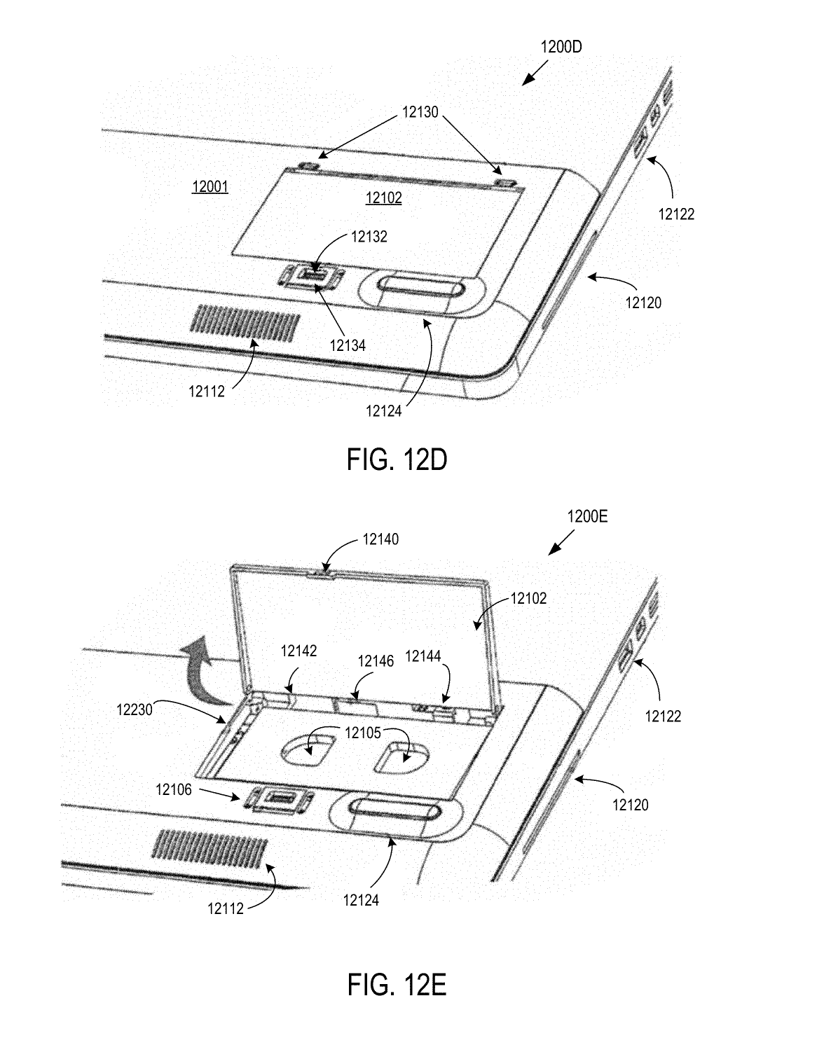

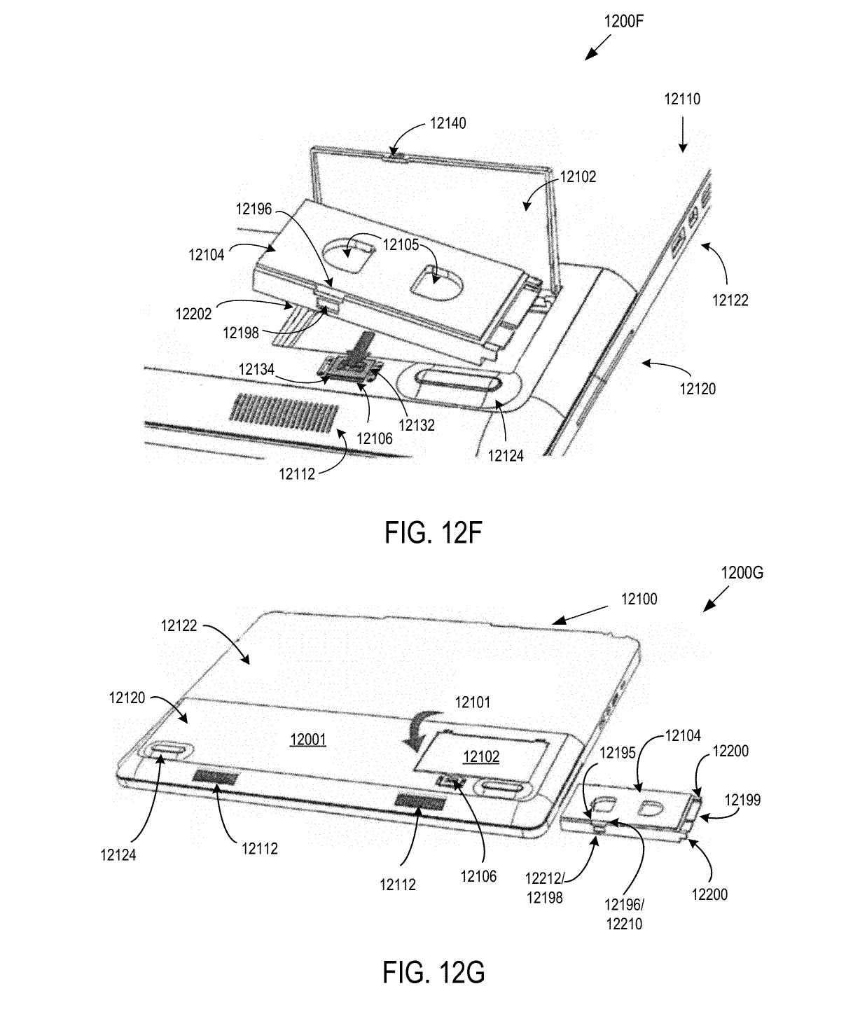

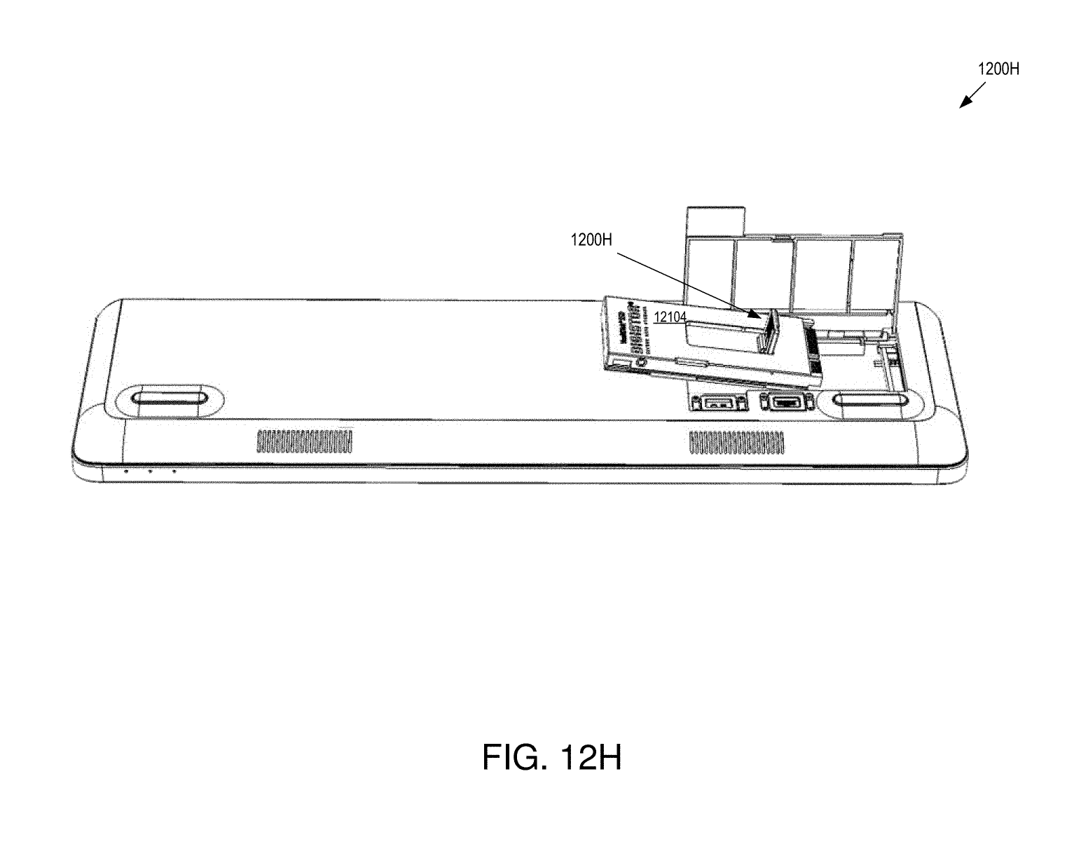

FIGS. 12A-12H are diagrams 1200A-1200G showing examples of a laptop device having an RBD enclosure, and capable of being coupled to an RBD. The example of FIG. 12A shows a perspective of a partial bottom view of a laptop device 12100 with a battery panel 12001 having an RBD enclosure 12003 therein. In this example, the battery panel 12001 includes an RBD 12104, a lid 12102, and an RBD enclosure 12003. The RBD 12104 is removable, as will be further discussed relative to subsequent figures and related discussion. The battery panel 12001 is shown to include an ejection mechanism 12106. For reasons that will be evident shortly, example of FIG. 12A is particularly useful in small form factor laptops because one of the functions of the kit is to function as a boot-drive where the RBD 12104 uses its non-volatile memory, such as solid state memory, to store boot-up code. Boot-up code is utilized by one of the processors of the laptop device 12100 to initialize and start up the laptop upon the powering up of the laptop.

In some implementations, the battery panel 12001 includes foot rests 12124. There may be four foot rests, one at each corner of the bottom of the laptop device 12100 to protect the bottom from contact with surfaces onto which the laptop device 12100 may be placed. Similarly, the laptop device 12100 may have air vents, such as air vents 12112, in FIG. 12A. The air vents 12112 may allow air flow and circulation to maintain a working temperature for the parts inside of the laptop device 12100.

In the example of FIG. 12A, the RBD 12104 is shown to include the locking mechanism 12195 and finger grips 12105. In some implementations, the RBD 12104 slips into the RBD enclosure 12003 when the lid is in an open position, as shown, and essentially snapped into the RBD enclosure 12003. The finger grips 12105 may house fingers of a user for a better grip in placing into the RBD enclosure 12003 and removing out of the RBD enclosure 12003, the RBD 12104. The user slips two fingers, each in a respective finger grip to pull out the RBD 12104, during removal of the RBD 12104 and insertion of the RBD 12104 into the RBD enclosure 12003. While shown to be in a specific shape—generally an acorn—, the finger grips 12105 may be of any suitable shape and number and can be located anywhere on the RBD 12104 that would allow ease of removal and placement of the RBD 12104.

The battery panel 12001 is shown to include the ejection mechanism 12106 and the RBD 12104 is shown to include locking mechanism 12195. Additionally, the RBD 12104 is shown to include a robust RBD interface 12110 and the RBD enclosure 12003 is shown to include mating SATA connectors 12108. The RBD 12104, in an implementation, is a SATA-compliant drive, thus, its connectors are similarly SATA-compliant. Serial Advanced Technology Attachment (“SATA”) is a standard adopted by the industry-at-large, that requires manufacturers to build products with connections, ports and certain couplings meeting specific standards.

The locking mechanism 12195 may be configured to snap into the ejection mechanism 12106 of the battery panel 12001 and may hold the RBD 12104 securely within the RBD enclosure 12003 when the RBD 12104 has been snapped into the ejection mechanism 12106. After the secure fitting of the RBD 12104 into the RBD enclosure 12003, the robust RBD interface 12110 may be inserted into mating SATA connectors 12108 with mounting SATA ports. The mating SATA connectors 12108 may be located within the mounting SATA ports and when inserted, the robust RBD interface 12110, which include SATA-compliant data and power connectors, mate with the mating SATA connectors 12108. SATA data and power connectors are standardized and distinct from one another. Therefore, each of the elements 12110 and 12108 include data and power connectors.

FIG. 12B shows a perspective view of the bottom of the laptop device 12100, showing an upper portion 12122 of the laptop device 12100 and a lower portion 12120 of the laptop device 12100.

It is worthy to note that the battery panel 12001 is specially designed to house the RBD enclosure 12003 and hold the lid 12102. In fact, the RBD enclosure 12003 and the RBD 12104 are intentionally designed to have physical dimensions similar, but not quite the same, as that of a hard disk drive, which is normally a part of an off-the-shelf laptop and placed and irremovable from the laptop. Whereas, in the various implementations, the RBD 12104 effectively and physically replaces the hard disk drive of the laptop and is removable. In the case of the various implementations, the RBD enclosure 12003 and RBD 12104 have the same width as a hard disk drive but have a slightly smaller length than a hard disk drive to prevent the SSD drive and/or RBD enclosure protrude into or below parts of the battery encapsulation.

The lid 12102 is shown to include one or more hinges 12130 at either end of a side opposite to that with the ejection mechanism 12106. These hinges serve to tighten the lid 12102 to the battery panel 12001 using screws, among other manners of securing the lid 12102 to the battery panel 12001. It should be noted that the lid 12102 is optional and in some embodiments is not present. Its role is basically to further protect the SSD drive but in applications where the shell of the SSD drive offers sufficient protection thereof, the lid 12102 may not be used.

FIG. 12C shows an exploded view of a part of the battery panel 12001 with the lid 12102 shown in a closed position. FIG. 12C is intended to show further details of the ejection mechanism 12106, attached to the battery panel 12001 using sets of tightened screws 12136 that are located on opposite sides of the ejection mechanism 12106.

In FIG. 12C and in accordance with an exemplary embodiment, the ejection mechanism 12106 is shown to include a wide notch 12134 inside of which is located a narrow notch 12132. Each of the notches 12134 and 12132 is used for a distinct stage of ejection. In this respect, the ejection mechanism 12106 is dual-staged with two distinct stages of ejection for ejecting and receiving the RBD 12104. Let's assume, for the purpose of illustration, that the RBD 12104 is positioned inside of the battery panel 12001, under the lid 12102 while the lid 12102 is in a closed position, as shown in FIG. 12C. The locking mechanism 12195 of the RBD 12104, which has two latches corresponding to the notches of the ejection mechanism 12106, each latch fitting into a corresponding notch to securely position the RBD 12104 inside the battery panel 12001. In this position, the RBD 12104 is removed upon first pressing one of its two latches within one of notches, causing the lid 12102 to open and pressing once again causing the other latch-notch combination to engage, popping out the RBD 12104 from the RBD enclosure 12003. Therefore, the RBD 12104 is caused to snap out of the RBD enclosure 12003 for removal by a two-stage ejection process.

To position the RBD 12104 inside the RBD enclosure 12003 and engage with the battery panel 12001, similarly, a two-stage process is performed. First, the RBD 12104 is snapped into the RBD enclosure 12003, using for example the wide notch 12134 of the lid 12102 and a corresponding latch of the RBD 12104 and then snapped further to fit the remaining latch of the RBD 12104 into the corresponding narrow notch 12132 of the lid 12102. At each stage, in an implementation, a clicking sound is heard to communicate the completion of each stage to the user.

FIGS. 12D and 12E each show a relevant portion of the laptop device 12100 to further depict details of the battery panel 12001, with the lid 12102 shown in the closed position in FIG. 12D, and the lid 12102 shown in an open position in FIG. 12E with the RBD 12104 fully inserted in the RBD enclosure 12003 and residing in the battery panel 12001. In FIG. 12E, the lid 12102, shown opened, has a lip 12140 that when the lid is being closed, is inserted into a corresponding notch of the ejection mechanism 12106. On an opposite side of the lid 12102 is shown a set of wide notches 12142-12146 that are positioned in corresponding areas of the battery panel 12001 receiving these notches to secure the corresponding side of the lid 12102 in the battery panel 12001.

FIG. 12F shows an exploded view of the battery panel 12001 where the RBD 12104 is being removed from the RBD enclosure 12003 where latches 12198 and 12196 are ejected out of their corresponding notches 12132 and 12134. That is, latches 12196 and 12198, of the RBD 12104, form the locking mechanism 12195 of the RBD 12104. When the RBD 12104 is fully located in the RBD enclosure 12003, the latch 12198 of the RBD 12104 inserts itself inside of the notch 12132 of the ejection mechanism 12106 and the latch 12196 of the RBD 12104 inserts inside of the notch 12134 of the ejection mechanism 12106. As each latch inserts into a notch, in an implementation, a ‘click’ sound is heard by the user letting the user know about the completion of each stage of the dual-stage insertion. It should be noted that the locking mechanism of the RBD 12104 and the ejection mechanism of the battery panel 12001 may vary in different designs and do not need to be the same or similar to the ones shown and discussed herein.

In FIG. 12F, still further details of the RBD 12104 are shown where the RBD 12104 is shown to include guides 12200 located on opposite ends of the front side of the RBD 12104, positioned on either side of the Mating SATA connectors 12108. The mating SATA connectors 12108 is shown to include two separate connectors, i.e. the SATA data and power connectors 12199. The arrow shown below the RBD 12104 is intended to show the association between the ejection mechanism 12106 and the RBD 12104 upon removal of the latter from the RBD enclosure 12003. Similarly, the arrow pointing to the lid 12102, in FIG. 12G, is intended to show the closure of the lid 12102.

FIG. 12G shows the laptop device 12100 with the battery panel 12001, without the RBD 12104 inserted into the battery panel 12001. Instead, the RBD 12104 is shown on the right side of the battery panel 12001, outside of the laptop device 12100, to further depict the locking mechanism 12195 thereof, which is shown made of latches 12198 and 12196, also referenced as 12212 and 12210, respectively. FIG. 12H additionally shows an extension 12500 protruding from the RBD 12104.

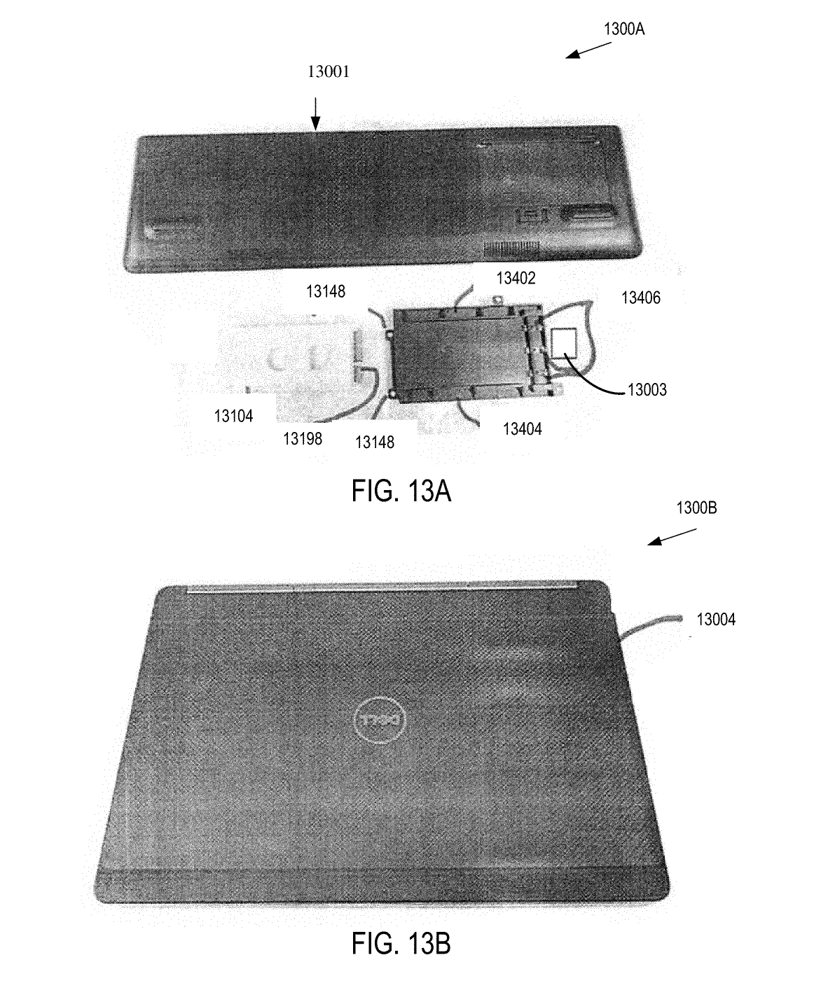

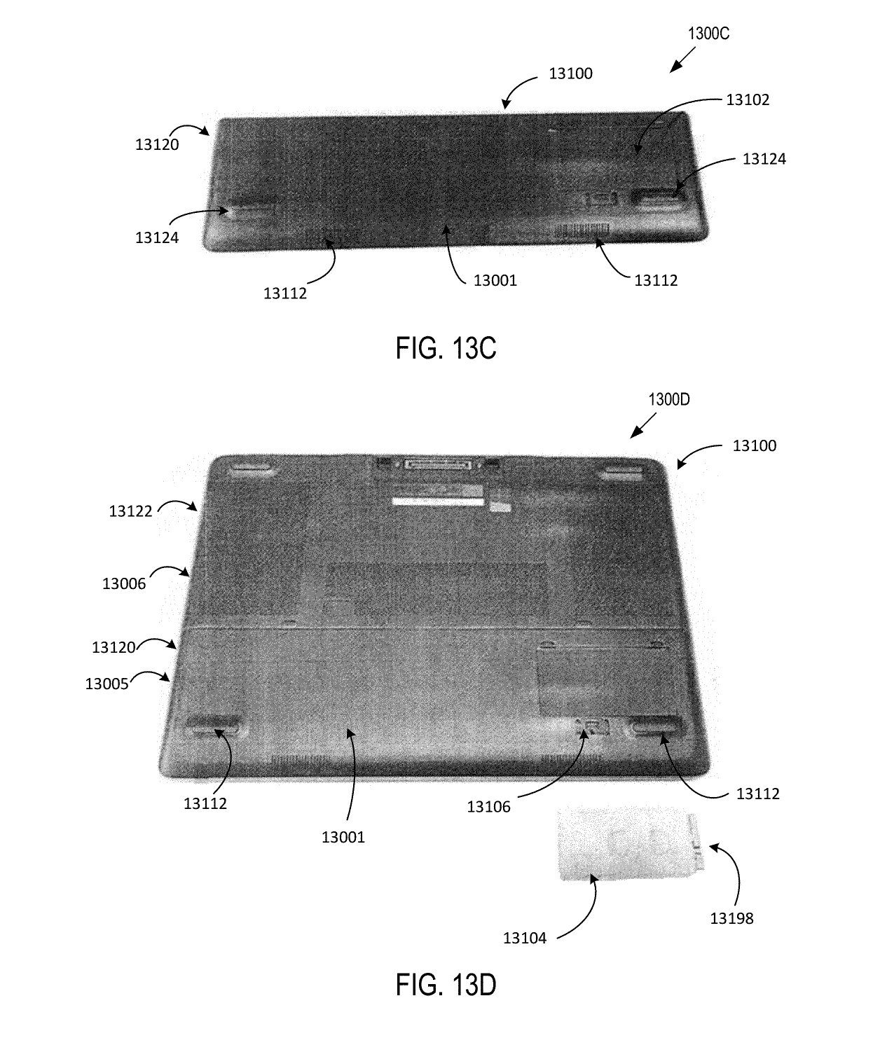

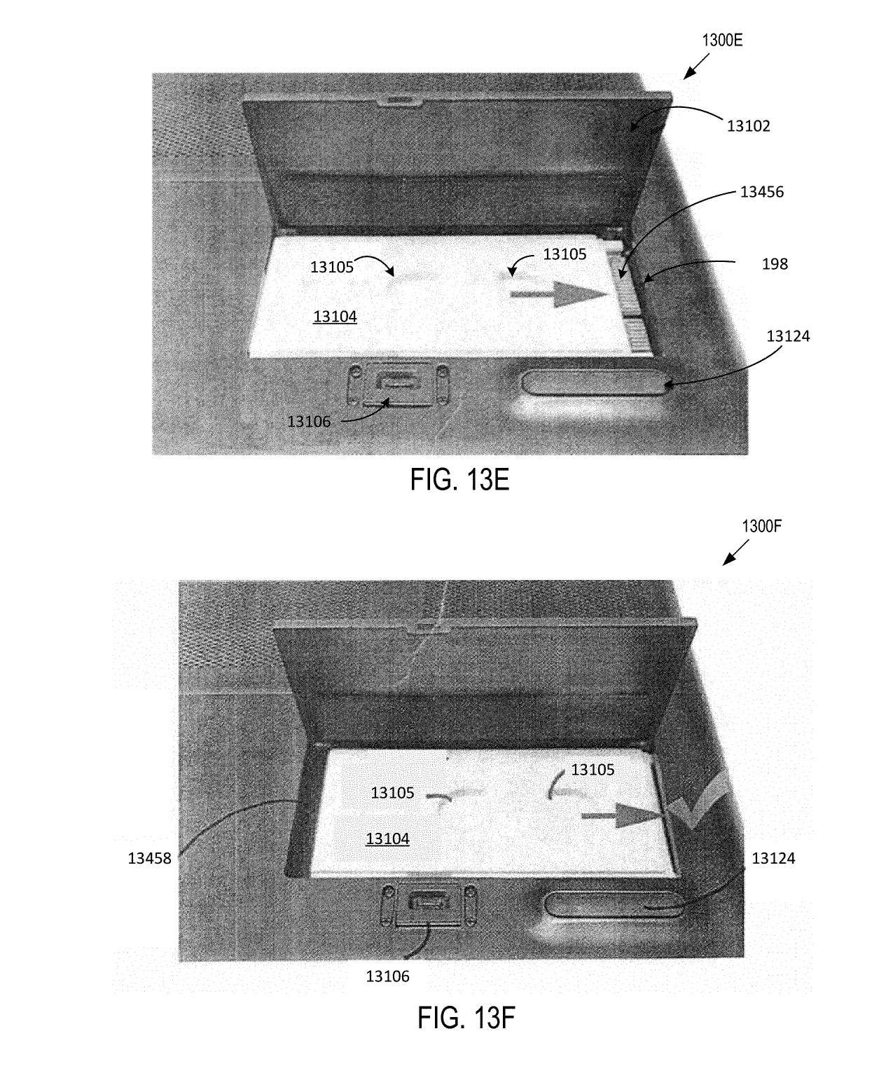

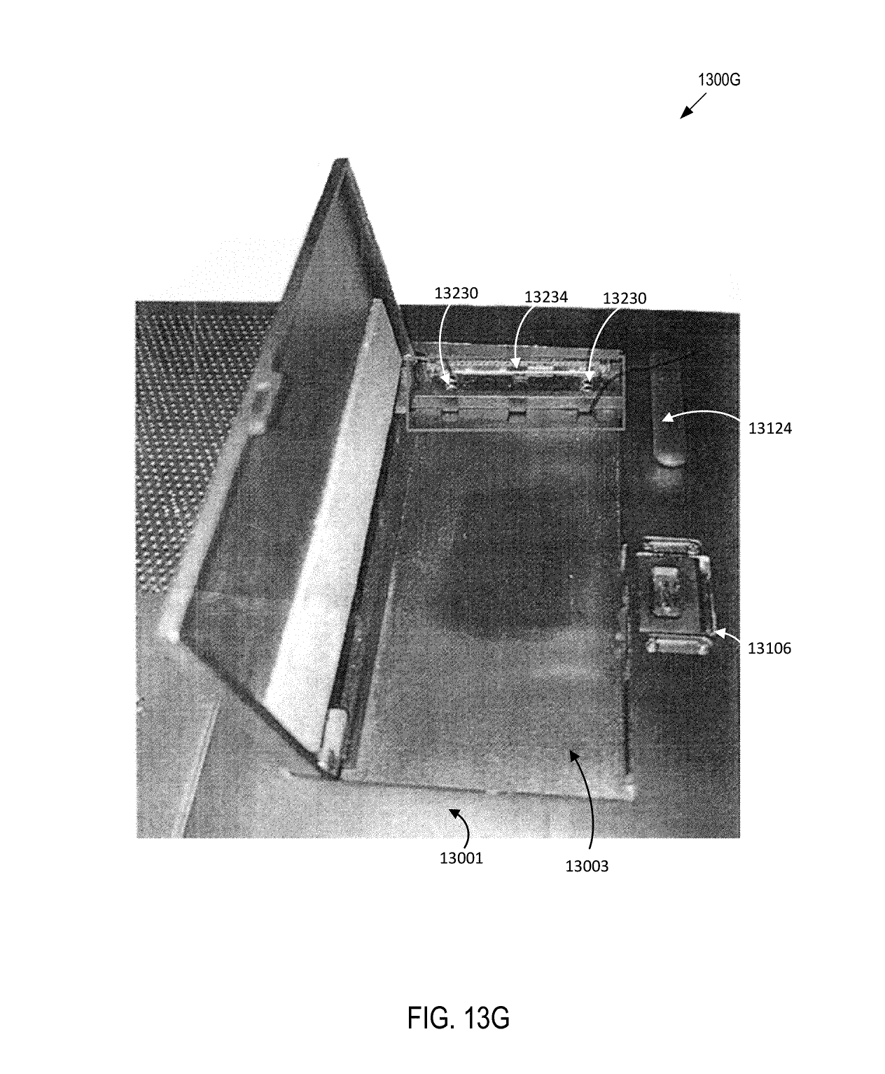

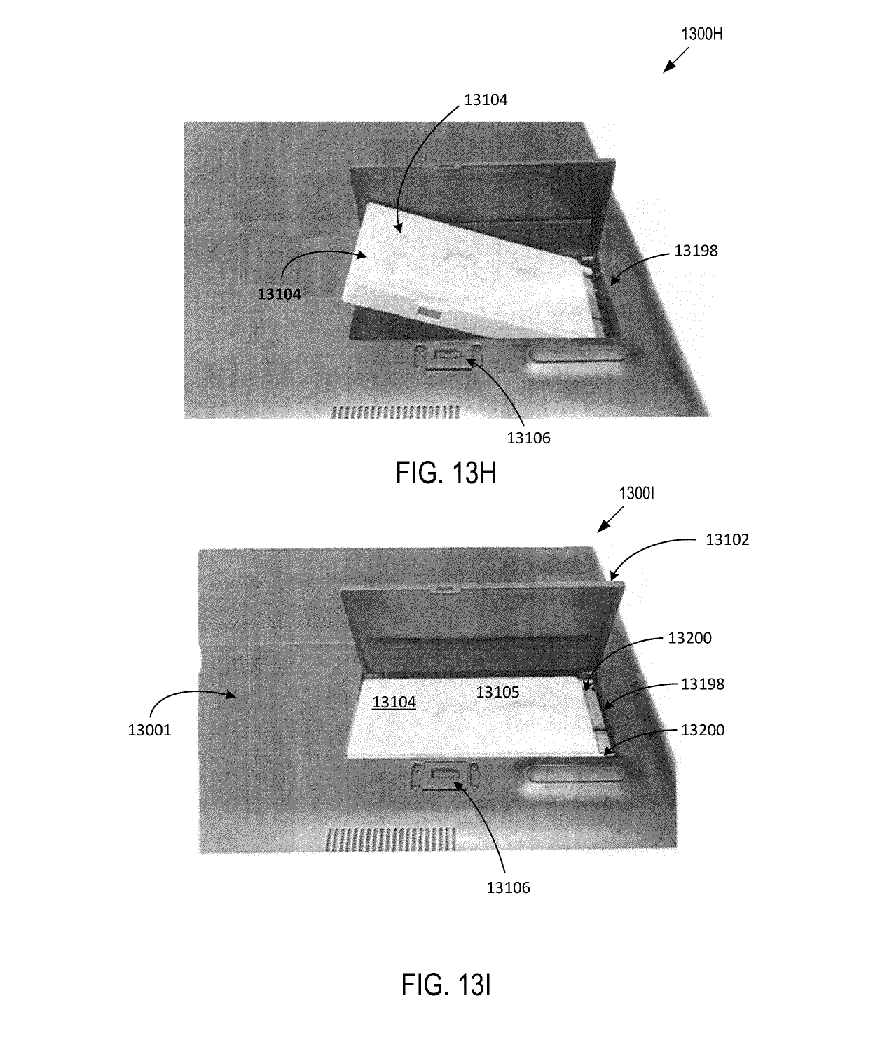

FIGS. 13A-13I are diagrams 1300A-1300I showing examples of a laptop device 13100 having an RBD enclosure 13003, and capable of being coupled to an RBD 13104.

FIG. 13A shows various components of a battery panel 13001, the RBD enclosure 13003 and the RBD 13104, in accordance with an implementation. The lid 13102 of the RBD enclosure 13003 is shown closed. The RBD enclosure 13003 is shown to have guides 13402 and 13404 extending along the two opposite and longer sides of the RBD enclosure, RBD enclosure connectors 13406 for carrying the SATA connectors 13110 of the RBD 13104, and hangers 13148, located at opposing sides of back of the RBD enclosure 13003 for securing the lid 13102 to the RBD enclosure 13003 by screws. The guides 13402 and 13404 serve to guide the two corresponding sides of the RBD 13104 as the RBD 13104 is being received by the RBD enclosure 13003. As will become apparent shortly, relative to subsequent figures and discussion, the sides of the RBD 13104 have matching recesses that are received, respectively, by the guides 13402 and 13404 of the RBD enclosure 13003.

FIG. 13B shows a front portion 13004 of the laptop device 13100. It is intended to show the laptop device 13100 to have exactly the same front portion as that of a standard laptop. FIG. 13C shows a photograph of the lower portion 13120 of the back of the laptop device 13100 with the lid 13102 in a closed position. The example of FIG. 13C includes air vents 13112 and foot rests 13124. FIG. 13D shows a photograph of the entire back of the laptop device 13100, with the lid 13102 shown in a closed position. FIG. 13D further shows a photograph of the RBD 13104. An upper portion 13122 is shown. The example of FIG. 13D includes the air vents 13112 and the foot rests 13124.

FIGS. 13E and 13F show the placement of the RBD 13104 into the RBD enclosure 13003, with the lid 13102 in an open position, but at two different and sequential stages of insertion of the RBD 13104. When the RBD 13104 is initially snuggly placed into the RBD enclosure 13003 by use of the ejection mechanism 13106 of the RBD enclosure 13003 and the locking mechanism 13195 of the RBD 13104, SATA connectors 13110 remain exposed and more importantly unconnected to the mating SATA connectors 13108, with the exposure of the SATA connectors 13110 separated from an edge of the RBD enclosure 13003 where the RBD 13104 is to be inserted by a gap 13456. When the RBD 13104 is initially inserted into the RBD enclosure 13003, it is therefore, aligned with and inserted into the RBD enclosure and thereafter pushed down into the RBD enclosure 13003 to latch the locking mechanism 13195 of the RBD 13104 with the ejection mechanism of the RBD enclosure 13003. At this point, while the RBD 13104 is securely in the RBD enclosure 13003, it is not electrically connected to the laptop device 13100 because its SATA connectors 13110 are not making contact with the mating SATA connectors 13108, which provide electrical connection with the SATA data and power of the laptop device 13100. To make the RBD 13104 operational, as the two arrows in FIGS. 13E-13F indicate, the RBD 13104 must be pushed forward to the extent it can be and such that its SATA connectors 13110 suitably make connections with the mating SATA connectors 13108. Thereafter, the RBD 13104 is electrically and physically connected with the laptop device 13100 and can be used as a boot-up drive.

In FIG. 13F, once the RBD 13104 is pushed down into the RBD enclosure 13003 and then pushed forward, in a direction shown by the arrow, and is accordingly fully engaged, a gap 13458 is formed between the RBD 13104 and the battery package. This gap prevents protrusions into the battery compartment and results generally from the dimensions of the RBD 13104 being slightly different than a standard hard disk drive, as earlier indicated. Namely, the length of the RBD 13104 is shorter than that of standard hard disk drives by approximately 0.5″ although other size gaps may be employed. While the width of the RBD 13104 is not significantly affected, in some designs, it may be slightly smaller than that of standard hard disk drives to compensate for the size of the RBD enclosure 13003. As previously noted, the RBD 13104 is shown in both FIG. 13F and FIG. 13E to have finger grips 13105 for ease of placement and removal thereof from the RBD enclosure 13003.

FIG. 13G shows further details of the RBD enclosure 13003 as it is seated in the RBD enclosure 13003. As shown in the embodiment of FIG. 13G, the area, as shown in FIG. 13G, is enclosed by a square drawn for ease of identification, where the RBD 13104 (when present) connects with the mounting SATA ports 13234 of the RBD enclosure 13003. Additionally, a set of springs 13230, shown in FIG. 13G, are a part of the RBD enclosure 13003. Each of the two springs 13230 are shown located on opposite sides of the front of the RBD enclosure 1, ready to receive and engage with the front of the RBD 13104 as it is pushed to the front, such as shown and explained relative to FIG. 13. The springs flex upon the insertion of the RBD 13104 and more particularly, during the second stage of the insertion and pushing of the RBD 13104 toward the mating SATA drive connectors 13108 and mounting SATA ports 13234 of the battery panel. Accordingly, springs 13230 allow for flexibly and not rigidly receiving the RBD 13104 as its SATA data and power connectors 13199 make contact with the mating SATA drive connectors 13108 and the mounting SATA ports 13234.

FIGS. 13H and 13I show photographs of the RBD 13104 as it is inserted into the RBD enclosure 13003. As previously explained, the RBD 13104 is placed into the RBD enclosure 13003 more conveniently with the latch 13198 lowering toward the ejection mechanism 13106 while the opposite end of the RBD 13104 remains higher such that the RBD 13104 is at an angled position relative to the surface of the laptop device 13100. This opposite end of the RBD 13104 is then lowered as the front of the RBD 13104 is slightly pushed to the front to allow the opposite end to fit into the RBD enclosure but not far enough for the latch 13198 to fully engage with the ejection mechanism 13106. This process is assisted by the ejection mechanism 13106 as previously discussed. The example of FIG. 13I further shows guides 13200.

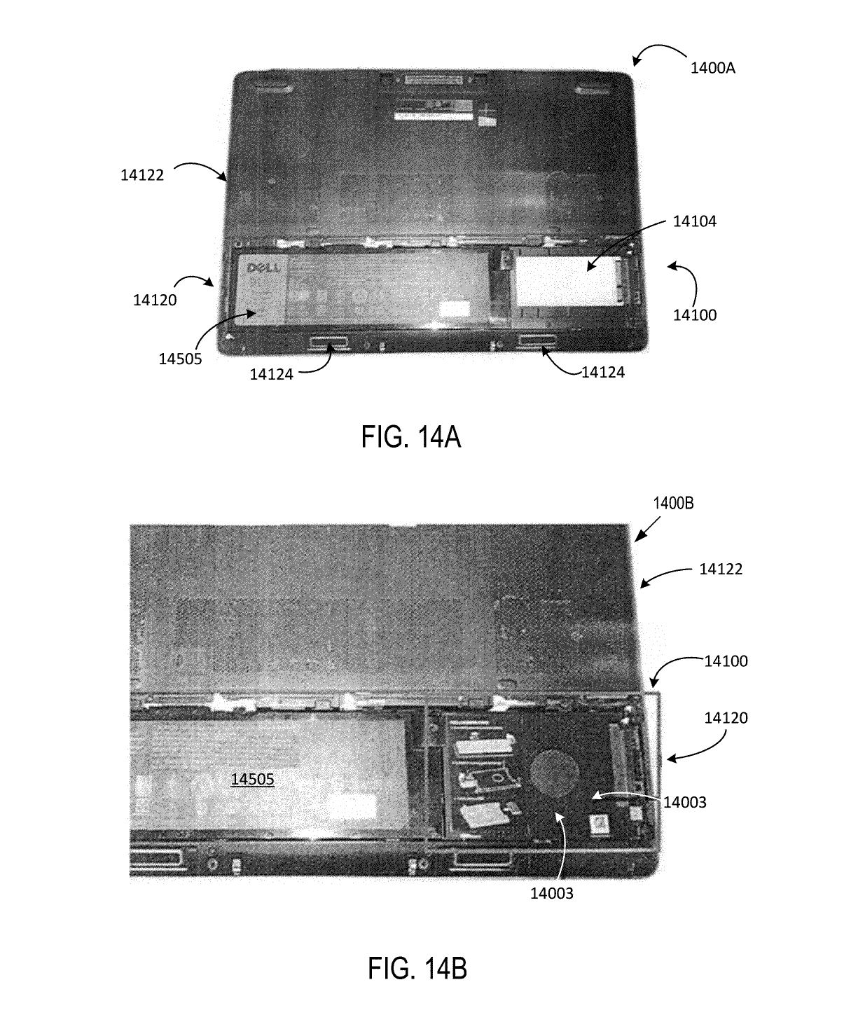

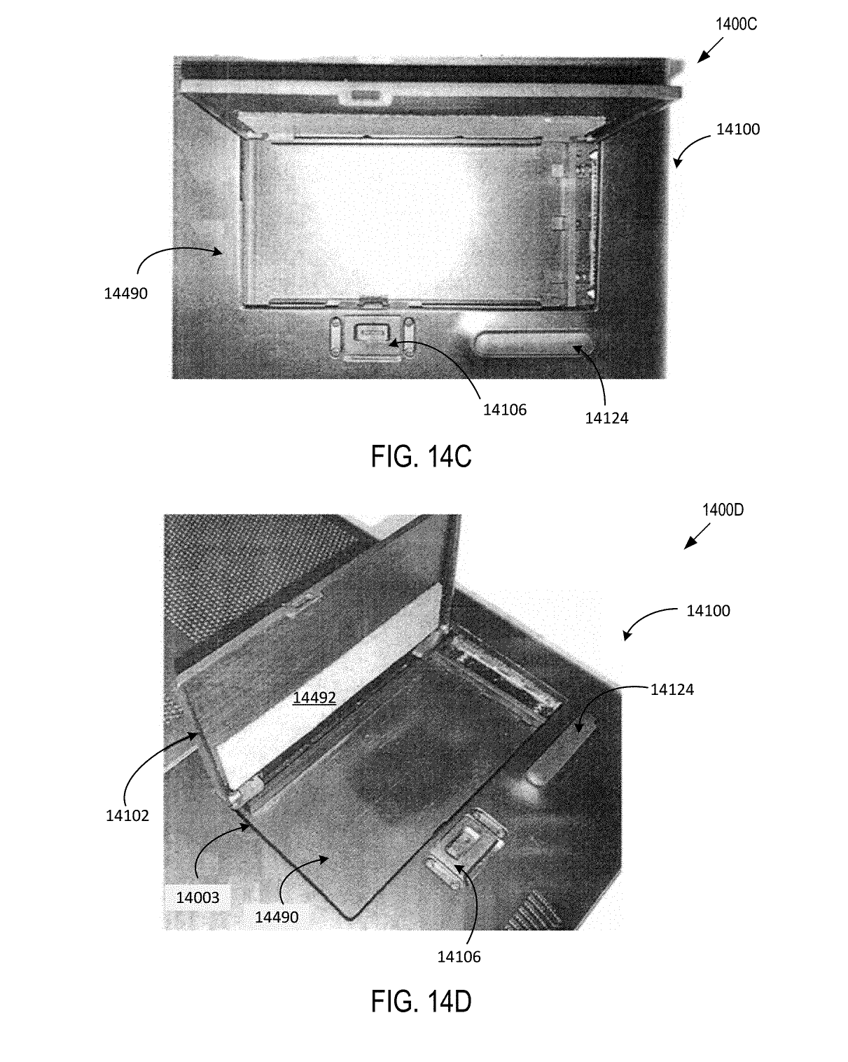

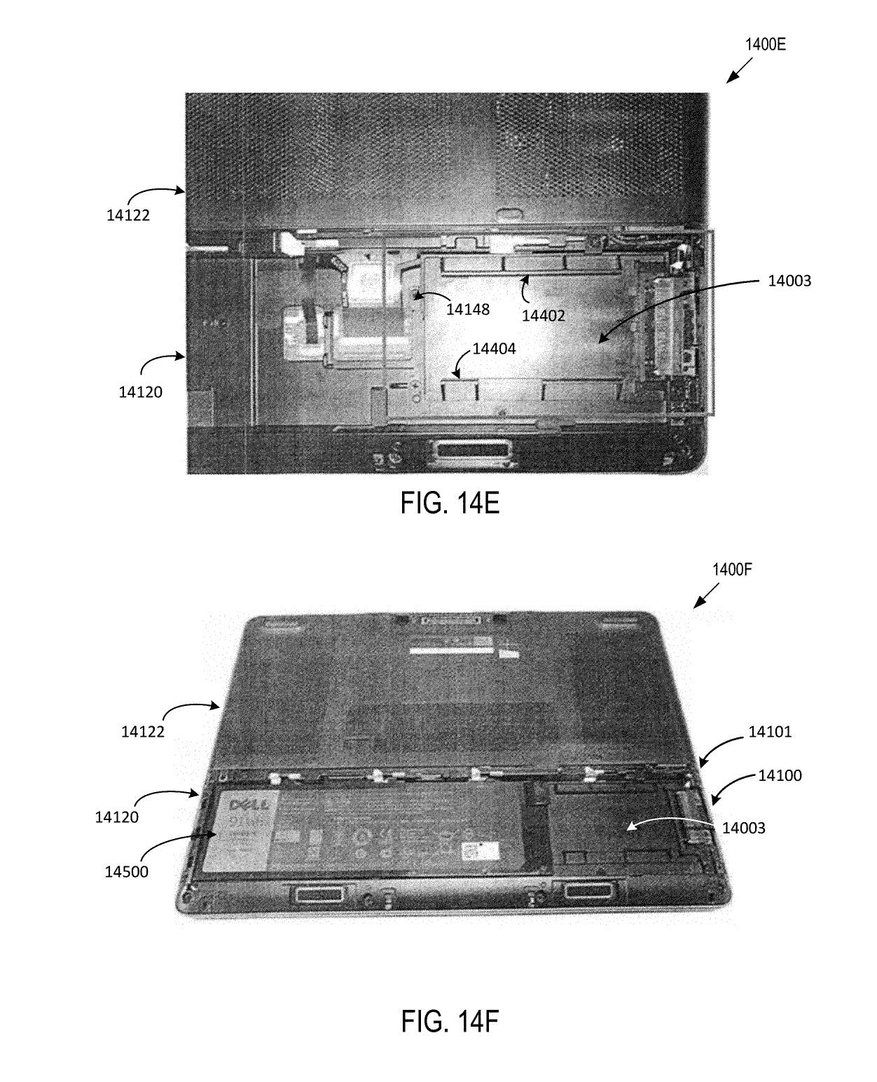

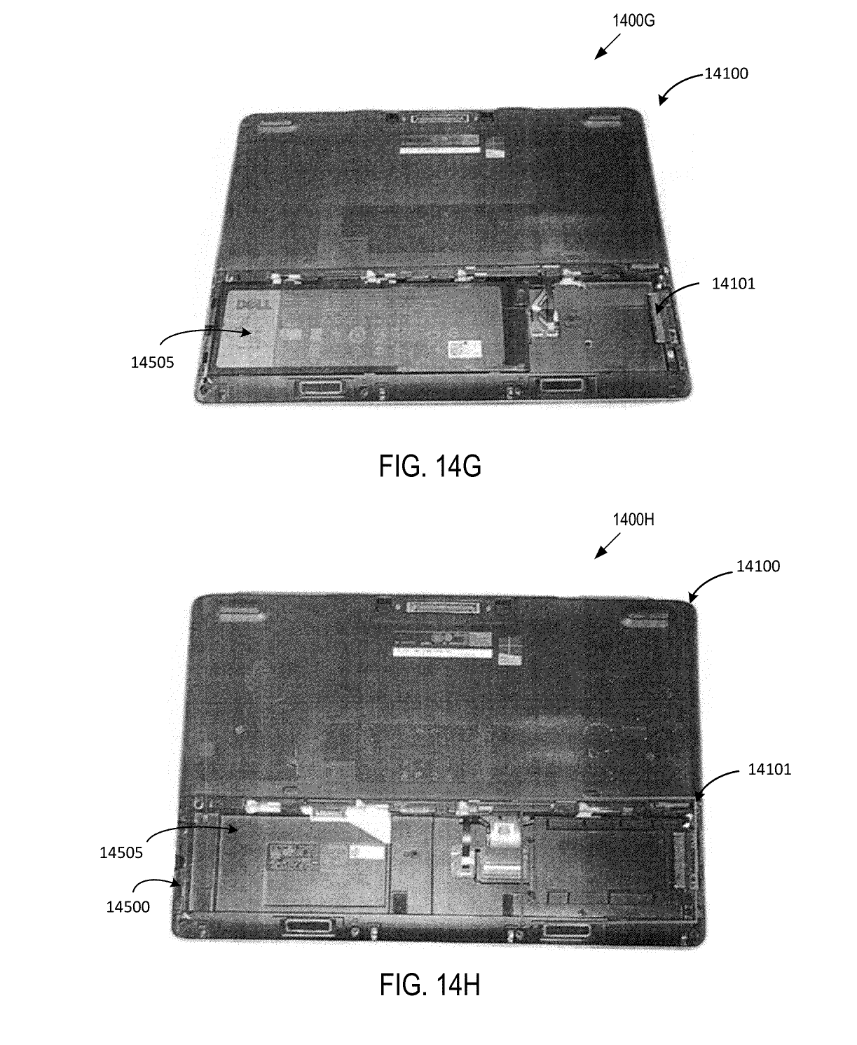

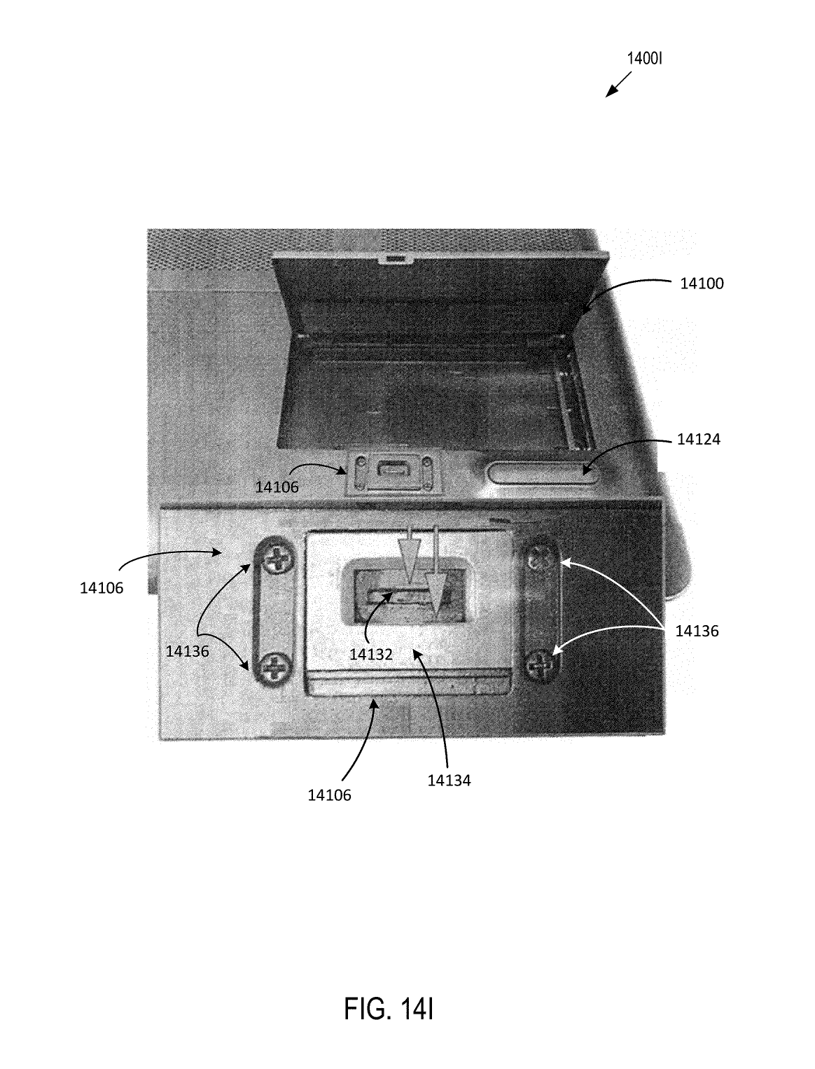

FIGS. 14A-14I are diagrams 1400A-1400I showing examples of a laptop device 14100 having an RBD enclosure 14003, and capable of being coupled to an RBD 14104. FIG. 14A shows a photograph of the laptop 14100 with the RBD 14104 seated in the RBD enclosure 14003 but the battery panel 14001, also referred to herein as the “cable cover” or the “cable cover plate”, removed thereby not only exposing the RBD 14104 but also exposing the battery 14505 of the laptop device 14100. A lower portion 14120, an upper portion 14122, and foot rests 14124 are shown. FIG. 14B shows a portion of the laptop device 14100 with a part of the battery 14505 and the kit 14101 shown. The kit 14101 is enclosed by a square drawn to bring attention to the kit 14101. In this figure, the kit 14101 is shown without the RBD 14104 thereby exposing the RBD enclosure 14003.

FIG. 14C shows a photograph of an exploded top view of the RBD enclosure 14003 shown with the surface 14495 of the RBD enclosure 14003 where the RBD 14104 sits exposed. A backplate 14490 is shown. FIG. 14D shows a photograph of an exploded top perspective view of the RBD enclosure 14003 showing the surface 14495 of the RBD enclosure 14003 along with the lid 14102. In the embodiment of FIG. 14D, a foam 14492 is shown covering a lower portion of the lid 14102 for further protection of the RBD 14104 and the lid 14102.

FIG. 14E shows a photograph of an exploded top view of the RBD enclosure 14003 exposing the guides 14402 and 14404, identified by the square drawn around the RBD enclosure 14003. Further shown in FIG. 14E is the hangers 14148 located between the back of the RBD enclosure 14003 and the parts forming the battery 14505 and/or parts related thereto. FIG. 14F shows a photograph of a top view of the back of the laptop device 14100 with the kit 14101 and absent the battery panel 14001, exposing the battery 14505 and RBD enclosure 14003.

FIGS. 14G and 14H show photographs of the back of the laptop device 14100, in accordance with implementations. In FIG. 14G, the laptop device 14100 is shown with the battery 14505 exposed because the battery panel 14001 is removed while FIG. 14H shows a photograph of the back of the laptop device 14100 with the battery 14505 and the battery panel 14001 both removed. As a result, an area 14500 where generally the battery 14505 is located within the laptop device 14100. The area 14500 is shown to include a bottom surface on top of which the battery 14505 is located when the latter is placed into the laptop device 14100 such as shown in FIG. 14G.

FIG. 14I shows a photograph of an exploded view of the ejection mechanism 14106 of the laptop device 14100. In particular, the ejection mechanism 14106, with the notches 14132 and 14134, is shown installed into the battery panel 14001 via the screws 14136. The arrows pointing to the notches 14132 and 14134 show the two-stage ejection with the notch 14134 causing the lid 14102 to open and the notch 14132 causing the RBD 14104 to snap out of the RBD enclosure 14003 during the removal of the RBD 14104 from the laptop device 14100.

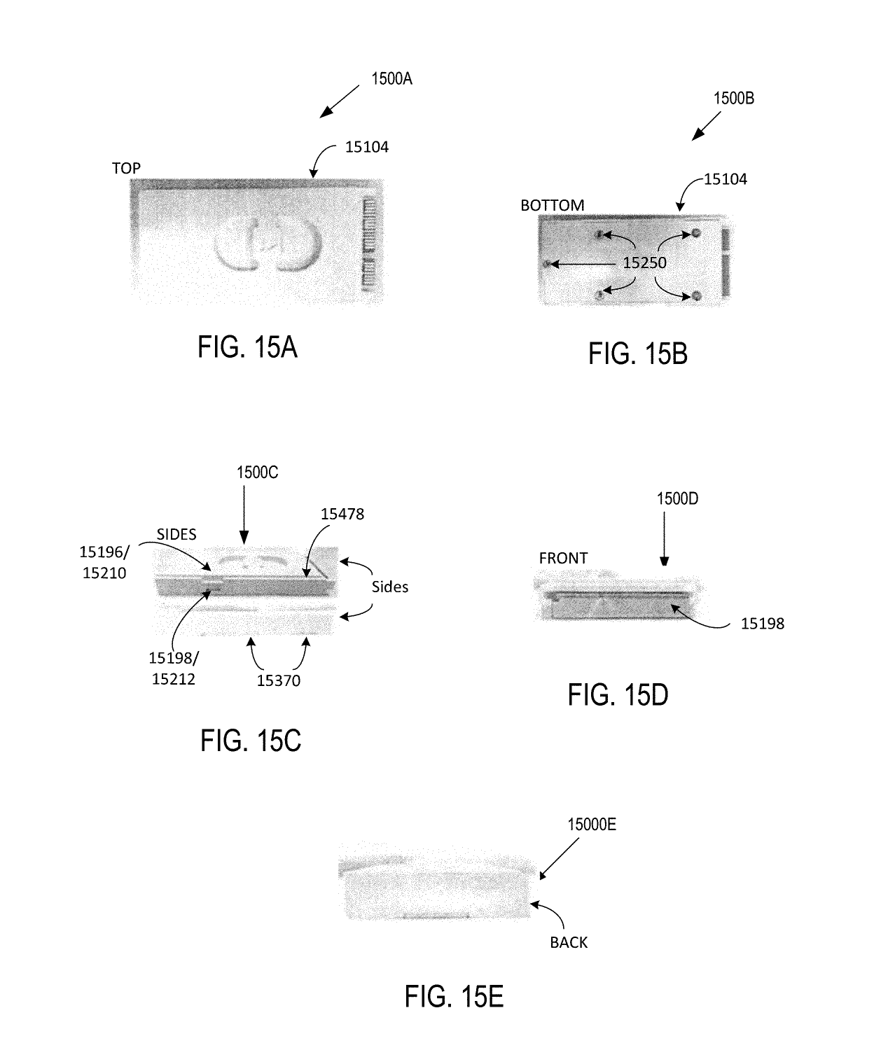

FIGS. 15A-5E are diagrams 1500A-1500I showing examples of an RBD 15104. FIGS. 15A-15E show various sides of the RBD 15104, in accordance with embodiments of the invention. FIG. 15A shows a photograph of a top view of the RBD 15104, clearly showing the finger grips 15105. FIG. 15B shows a photograph of the bottom of the RBD 15104 with five screws 15250 shown tightened through the various sides of the RBD 15104 for enclosure and protection of the non-volatile memory located inside of the RBD 15104. FIG. 15C shows photographs of the longer sides of the RBD 15104. In this respect, one side of the RBD 15104 is shown to include the latches 15196/15210 and 15198/15212. In the bottom photograph of FIG. 15C, an opposite side of the RBD 15104 is shown to include indentations 15370 with a pattern that is complimentary to a pattern on a corresponding side of the caddy 15003 that comes in contact with the RBD 15104 when the RBD 15104 is completely seated within the caddy 15003. The RBD 15104 may include an edge 15478. Similarly, in some embodiments of the invention, the side of the RBD 15104 where the latches 15196 and 15198 are located, may also have a pattern of indentations that have a complimentary pattern corresponding to the same side of the caddy 15003 when the RBD 15104 is fully seated within the caddy 15003. FIG. 15D shows a photograph of the front of the RBD 15104 with the latch 15198 exposed, and FIG. 15E shows a photograph of the back of the RBD 15104.

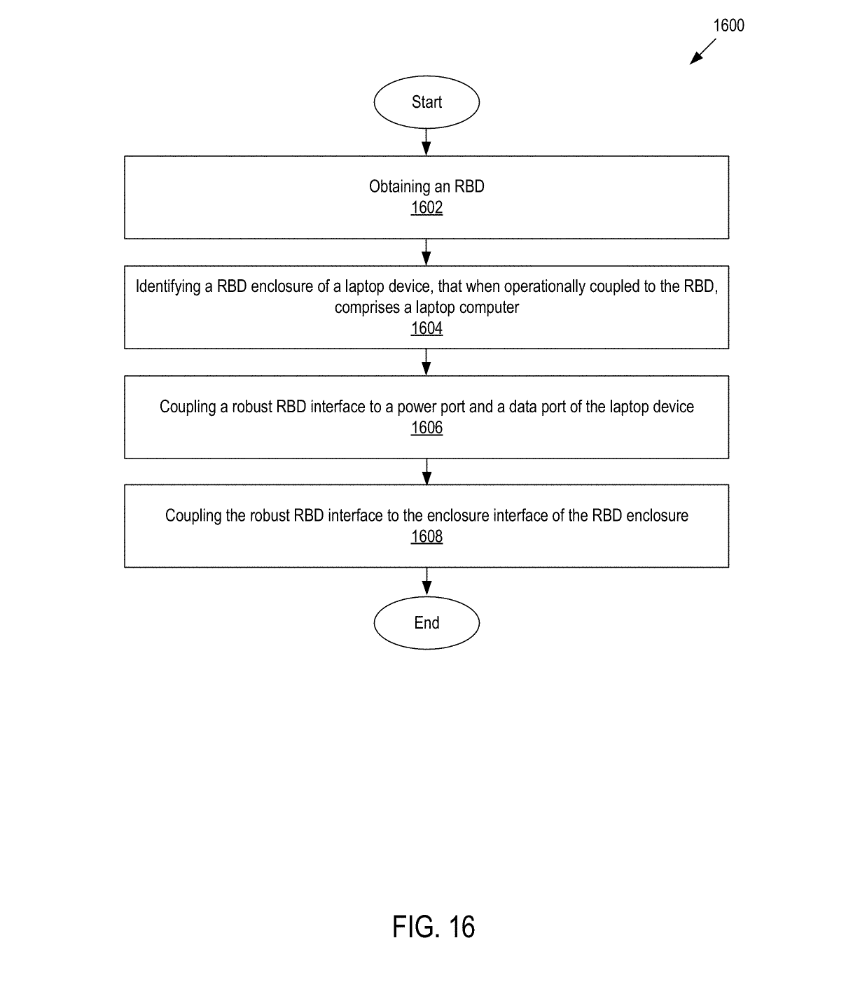

FIG. 16 is a diagram showing a flowchart 1600 of an example of a method of using an SFF device and an RBD. The method may be performed by one or more of the structures discussed in this paper. At module 1602, an RBD may be obtained. At module 1604, an RBD enclosure of a laptop device, that when coupled to the RBD, comprises a laptop computer (e.g., with memory and/or processor(s)) may be identified. At module 1606, a robust RBD interface of the RBD may be coupled to a power port and a data port of the laptop device. At module 1608, the robust RBD interface may be coupled to an enclosure interface of the RBD enclosure.

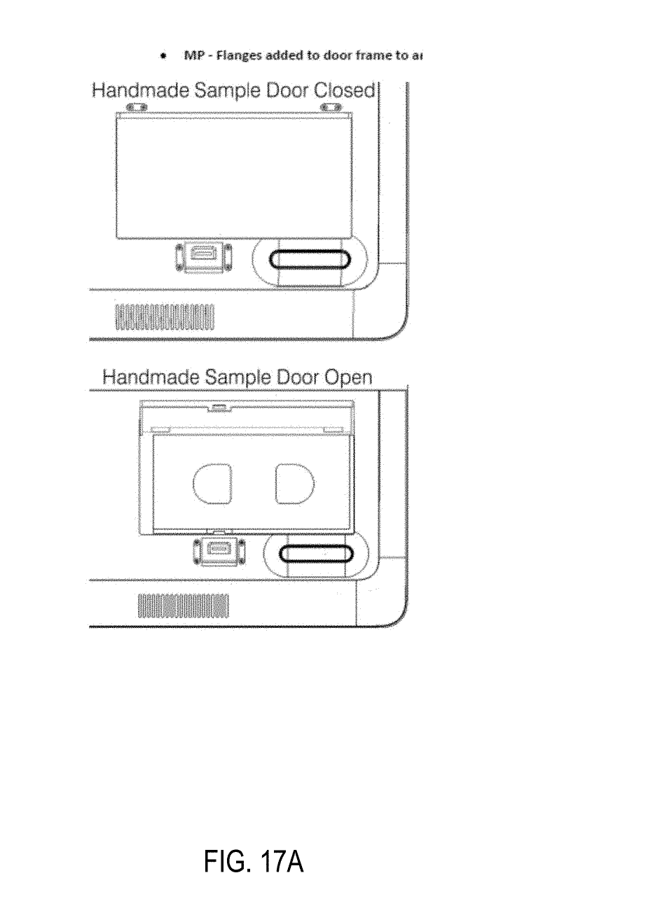

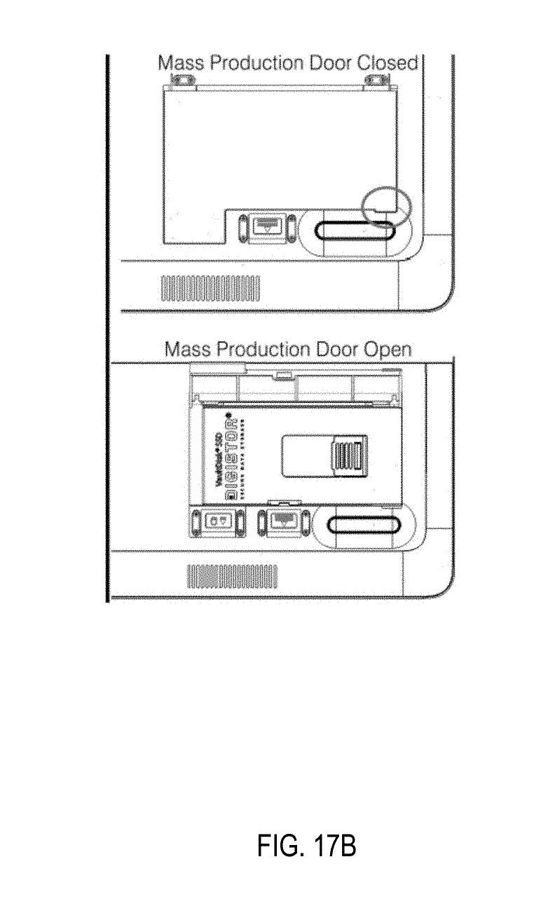

FIGS. 17A and 17B are diagrams 1700A and 1700B showing examples of an RBD enclosure. In the example of 17A, the RBD enclosure may be rectangular with a single door open/eject point. In the example of 17B, the RBD enclosure door shape may include a jutted partition which covers a secondary eject button. The main lever door may open. The secondary lever underneath the jutted partition may eject the RBD. Flanges added to the door frame may allow firm closure when the RBD is not installed.

Several components described in this paper, including clients, servers, and engines, may be compatible with or implemented using a cloud-based computing system. As used in this paper, a cloud-based computing system is a system that provides computing resources, software, and/or information to client devices by maintaining centralized services and resources that the client devices may access over a communication interface, such as a network. The cloud-based computing system may involve a subscription for services or use a utility pricing model. Users may access the protocols of the cloud-based computing system through a web browser or other container application located on their client device.

This paper describes techniques that those of skill in the art may implement in numerous ways. For instance, those of skill in the art may implement the techniques described in this paper using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used in this paper, the term ‘processor’ refers to one or more devices, circuits, and/or processing cores configured to process data, such as computer program instructions.

A detailed description of one or more implementations of the invention is provided in this paper along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described in this paper relate to apparatus for performing the operations. The apparatus may be specially constructed for the required purposes, or it may comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

We claim:

1. A removable bootable drive (RBD) device comprising:
an RBD housing;
an accessibility tab coupled to the RBD housing;
a quick-insertion guide formed in the RBD housing;
a robust RBD interface coupled to the RBD housing;
a storage device coupled to the robust RBD interface, wherein the storage device has boot software and operating system software stored thereon;
wherein, in operation, the accessibility tab provides a useful grip for an entity performing a task of mating the quick-insertion guide with a corresponding portion of a small form factor (SFF) device to facilitate operationally coupling the robust RBD interface with a corresponding power and data interface of the SFF device,
wherein, when the SFF device and RBD device are operationally combined to form an SFF computing device, the SFF computing device is bootable using the boot software and the SFF computing device operates in accordance with the operating system software.

2. The RBD device of claim 1, wherein the storage device includes a solid state drive (SSD).

3. The RBD device of claim 1, wherein the storage device includes an internal drive enclosed within the RBD housing.

4. The RBD device of claim 1, wherein the storage device includes an M Dot Two (M.2) drive or a Serial AT Attachment (SATA) drive.

5. The RBD device of claim 1, wherein the robust RBD interface is formed of a sturdy material.

6. The RBD device of claim 1, wherein the robust RBD interface is formed of polymethyl methacrylate (PMMA), polycarbonate, or modified PMMA or polycarbonate.

7. The RBD device of claim 1, wherein a first end of the RBD housing is narrower than a second end of the RBD housing to form a chamfered housing.

8. The RBD device of claim 1, wherein the accessibility tab includes an extension having ridges formed thereon.

9. The RBD device of claim 1, comprising a Radio Frequency Identifier (RFID) chip or a radio opaque identifier.

10. The RBD device of claim 1, wherein the quick-insertion guide includes a quick-insertion groove or a protrusion.

11. A small form factor (SFF) device, comprising:
a removable bootable drive (RBD) enclosure configured to receive an RBD device;
a quick-insertion guide formed within the RBD enclosure;
a power and data interface configured for operational coupling with a robust RBD interface;
a friction-reducing air gap located inside the RBD enclosure;
wherein, in operation, the quick-insertion guide is mated with a corresponding portion of the RBD device, as part of an operation during which the RBD device is inserted along the friction-reducing air gap, to facilitate operationally coupling the power and data interface with the robust RBD interface;
wherein, when the SFF device and RBD device are operationally combined to form an SFF computing device, the SFF computing device is bootable using boot software stored in the RBD device and the SFF computing device operates in accordance with operating system software stored in the RBD device.

12. The SFF device of claim 11, wherein the quick-insertion guide includes a quick-insertion groove or a protrusion.

13. The SFF device of claim 11, wherein, when the SFF device is not operationally combined with the RBD device or another RBD device, the SFF device is inoperable as a computing device.

14. A system comprising:
a removable bootable drive (RBD) enclosure configured to receive an RBD device;
a power and data interface configured for operational coupling with a robust RBD interface;
a storage device implemented in the RBD device and coupled to the robust RBD interface, wherein the storage device has boot software and operating system software stored thereon;
wherein, a small form factor (SFF) computing device is bootable using boot software stored in the RBD device and the SFF computing device operates in accordance with operating system software stored in the RBD device.

15. The system of claim 14, comprising a quick-insertion guide formed within the RBD enclosure.

16. The system of claim 14, comprising a friction-reducing air gap located inside the RBD enclosure.

17. The system of claim 14, comprising a quick-insertion guide formed within the RBD enclosure, wherein, in operation, the quick-insertion guide is mated with a corresponding portion of the RBD device, as part of an operation during which the RBD device is inserted along a friction-reducing air gap, to facilitate operationally coupling the power and data interface with the robust RBD interface.

18. The system of claim 14, comprising an accessibility tab coupled to the RBD device, wherein, in operation, the accessibility tab provides a useful grip for an entity inserting or removing the RBD device.

19. The system of claim 14, comprising a quick-insertion guide formed in the RBD device, wherein, in operation, the quick-insertion guide is mated with a corresponding portion of the SFF computing device.

20. The system of claim 14, comprising a robust RBD interface coupled to the RBD device, wherein, in operation, the robust RBD interface is sufficiently sturdy to ensure repeated insertion and removal of the RBD device without breakage.
